(19) United States
(12) Patent Application Publication
(10) Pub. No.: US 2019/0110110 A1
(43) Pub. Date: Apr. 11, 2019

(54) RECORDING MEDIUM RECORDING CONTENT DISPLAY PROGRAM, CONTENT DISPLAY METHOD, AND INFORMATION PROCESSING APPARATUS

(71) Applicant: FUJITSU LIMITED, Kawasaki-shi (JP)

(72) Inventor: Yasuyuki Yoshiga, Fukuoka (JP)

(73) Assignee: FUJITSU LIMITED, Kawasaki-shi (JP)

(21) Appl. No.: 16/150,326

(22) Filed: Oct. 3, 2018

(30) Foreign Application Priority Data
Oct. 11, 2017 (JP) 2017-197711

(51) Int. Cl. H04N 21/488; G06F 3/16; G06F 17/30; G06T 11/20

(52) U.S. Cl. CPC H04N 21/4882; G06T 11/206; G06F 17/30958; G06F 3/167

(57) ABSTRACT

A non-transitory computer-readable recording medium for recording a content display program, the content display program causing a computer to execute processing, the processing includes displaying, in displaying a list of content, when sound information having an amount that satisfies a specific condition is added to the content, a first type of mark indicating that the content is viewable with the sound information in association with the content, and not-displaying, when the sound information is not added to the content, the first type of mark in association with the content.

### CROSS-REFERENCE TO RELATED APPLICATION

This application is based upon and claims the benefit of priority of the prior Japanese Patent Application No. 2017-197711, filed on Oct. 11, 2017, the entire contents of which are incorporated herein by reference.

### FIELD

The embodiments discussed herein are related to a recording medium that records a contents display program, a content display method, and a content display apparatus.

### BACKGROUND

To display a list of displayable contents on a network, icons indicating the contents are displayed.

Related techniques are disclosed in Japanese Laid-open Patent Publication No. 2000-293576 or International Publication Pamphlet No. WO 2002/019295.

### SUMMARY

According to an aspect of the embodiments, a non-transitory computer-readable recording medium for recording a content display program, the content display program causing a computer to execute processing, the processing includes: displaying, in displaying a list of content, when sound information having an amount that satisfies a specific condition is added to the content, a first type of mark indicating that the content is viewable with the sound information in association with the content; and not-displaying, when the sound information is not added to the content, the first type of mark in association with the content.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view illustrating an example of a content display method;

FIG. 2 is a view illustrating an example of marks that vary according to the level of addition of sound information;

FIG. 3 is a view illustrating an example of a comic content offering system;

FIG. 4 is a view illustrating an example of a hardware configuration of a server;

FIG. 5 is a view illustrating an example of a hardware configuration of a user terminal device;

FIG. 6 is a view illustrating an example of contents of a comic content;

FIG. 7 is a view illustrating an example of contents of image information;

FIG. 8 is a view illustrating an example of contents of sound information;

FIG. 9 is a view illustrating an example of contents of a registration state DB;

FIG. 10 is a view illustrating an example of contents of mark information;

FIG. 11 is a block diagram illustrating an example of a functional configuration of the server;

FIG. 12 is a view illustrating an example of a functional configuration of a user terminal device;

FIG. 13 is a view illustrating an example of comic content registration processing of the server;

FIG. 14 is a view illustrating an example of comic content registration acceptance processing of the user terminal device;

FIG. 15 is a view illustrating an example of comic content offering processing of the server;

FIG. 16 is a view illustrating an example of comic content request acceptance processing of the user terminal device;

FIG. 17 is a view illustrating an example of a log-in screen displayed on the user terminal device;

FIG. 18 is a view illustrating an example of a home screen displayed on the user terminal device;

FIG. 19A is a view illustrating an example of a comic content list screen displayed on the user terminal device;

FIG. 19B is a view illustrating an example of a comic content list screen displayed on the user terminal device;

FIG. 20A is a view illustrating an example of a comic content detail screen displayed on the user terminal device;

FIG. 20B is a view illustrating an example of a comic content detail screen displayed on the user terminal device;

FIG. 21 is a view illustrating an example of a recording screen displayed on the user terminal device;

FIG. 22 is a view illustrating an example of a sound information list screen displaying sound information for each voice actor;

FIG. 23 is a view illustrating an example of an appreciation screen displayed on the user terminal device; and

FIG. 24 is a view illustrating an example of marks that vary according to the registration level of sound information.

### DESCRIPTION OF EMBODIMENTS

For example, in creating shared information (documentation) via a network, an icon changed in color according to the progress of each process (person in charge) is displayed. As an example, in learning using the Internet, a character gradually grows according to the progress of a student.

For example, sound information may be added to the displayable content to increase the level of completeness or development. In this case, when the icon is merely displayed, the user may not recognize that sound information is added to the work. As a result, the user may not easily recognize the state of the work.

For example, information that allows the user to easily recognize the state of the content may be offered.

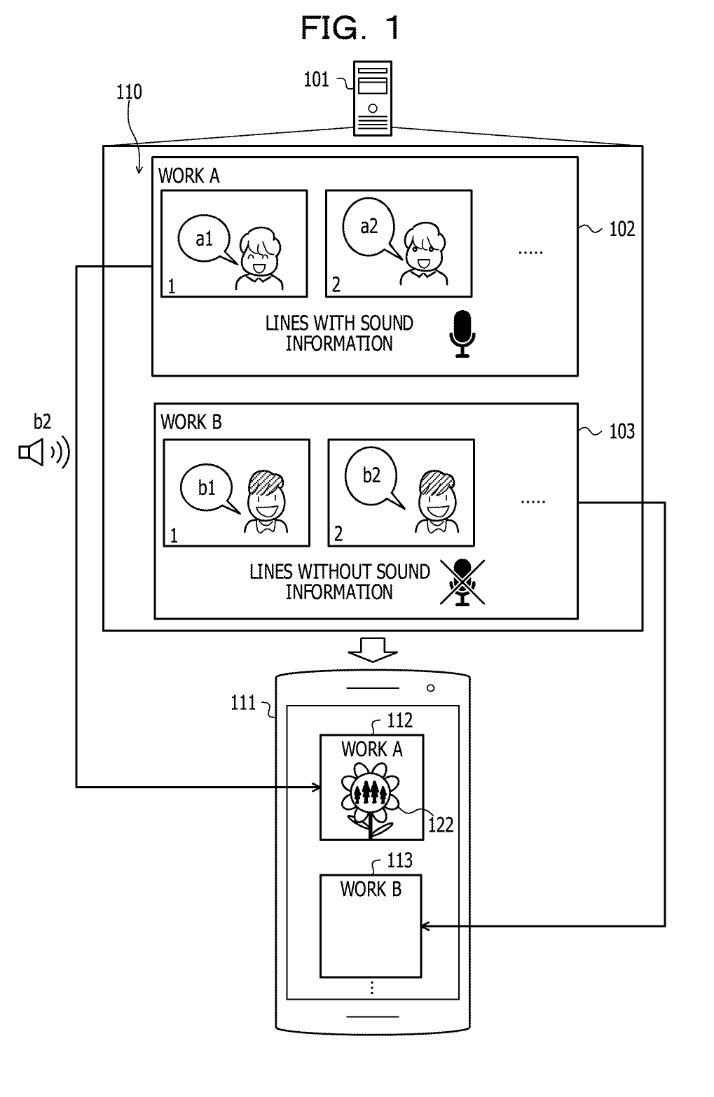

FIG. 1 illustrates an example of a content display method. In FIG. 1, a server 101 distributes comic data on registered comic works (hereinafter referred to as “comic content”) 102, 103 to a user terminal device 111. The user of the comic content (hereinafter referred to as “audience”) may appreciate the distributed comic content using, for example, the user terminal device 111.

The comic content includes image information on the comic created by the user (a content provider such as professional or armature comic artist (hereinafter referred to as “comic artist”)), which consists of a plurality of frames including a character and a balloon in which character's lines are described in letters. The character may be any character who speaks lines in the comic content. Examples of the character include animals, plants, aliens, and non-biological objects such as automobiles as long as they speak lines in the comic content, and are not limited to “person”. The balloon is a box that surrounds words spoken or thought by the character.

Reproducible sound information may be added to lines in the balloon in the image information of the comic, and registered in the comic content. The sound information includes sound information corresponding to each balloon and however, may include sound information that does not correspond to each balloon, for example, onomatopoeia displayed only in letters without the balloon. Examples of the sound information include voice information recorded by the user (a content provider such as professional or armature voice actor (hereinafter referred to as “voice actor”)), effective sound, and background sound.

The server 101 may store (record) a plurality of comic contents, accept a selection of the comic content desired by the audience, and transmit the selected comic content to the user terminal device 111, thereby distributing the comic content. The user terminal device 111 may display image information on the comic content received from the server 101, as well as output the received sound information.

In this manner, the audience may view the image information of the comic content as well as listen to the sound information corresponding to lines while viewing the image information, to experience a new view of world through the new content that is different from a usual comic (static images) and animation (dynamic images).

The server 101 accepts the registration of image information with lines from the comic artist. Thereby, the server 101 may register the comic content related to the image information. The server 101 accepts the registration of sound information corresponding to the image information of the registered comic content from the voice actor. Thereby, the server 101 may register the sound information corresponding to lines in the comic content.

Generally, the comic artist registers image information in the comic content, and the voice actor registers sound information corresponding to the lines in the balloon in the image information. In this manner, since image information and sound information are registered in different processes by different content providers, some comic contents include only the image information without added (registered) sound information, while other comic contents include the image information with added sound information. A list of these comic contents is displayed using icons or the like.

A ratio of an amount of added sound information to the entire lines varies according to comic contents. That is, as the case may be, the sound information is registered for all lines, lines of some of a plurality of characters, or some of all lines of one character. Alternatively, a plurality of pieces of sound information may be registered for the same lines.

The audience has various demands as follows: “sound information is not requested”, “sound information is requested for all lines”, and “sound information is requested for only the lines of a particular character”. Accordingly, since the registration state of sound information varies depending on the comic contents registered in the server 101, the audience may not easily recognize the registration state of the sound information of the comic content among a lot of registered comic contents to efficiently search a desired comic content.

The voice actor has various demands as follows: “his/her sound information is registered in the comic content including no sound information”, “his/her sound information is registered in the comic content including sound information of some of characters to improve the level of completeness of the comic content”, “his/her sound information is registered in the popular comic content including a lot or pieces of sound information to increase the his/her popularity”. Like the audience, the voice actor may not easily recognize the registration state of sound information of the comic content from the list of displayed comic contents to efficiently search a desired comic content, to which his/her sound information is to be offered.

In FIG. 1, in the comic content (work A) 102 having a line a1 and a line a2, which is registered in the server 101, image information and sound information corresponding to the line a1 and the line a2 are registered. When the sound information is registered in the comic content (for example, when an amount of sound information that satisfies a predetermined condition is added), in displaying an icon 112 in the work A on the user terminal device 111, a mark (first type of mark (flower mark)) 122 is displayed as the icon or with the icon. The mark 122 indicates that the comic content is viewable to the user with sound information. Details of the predetermined condition will be described later.

On the contrary, in the comic content (work B) 103 having a line b1 and a line b2, only image information is registered, and sound information corresponding to the line b1 and the line b2 is not registered. When sound information is not registered in the comic content (for example, when an amount of sound information that satisfies the predetermined condition is not added), in displaying an icon 113 in the work B on the user terminal device 111, the first type of mark (flower mark) is not displayed.

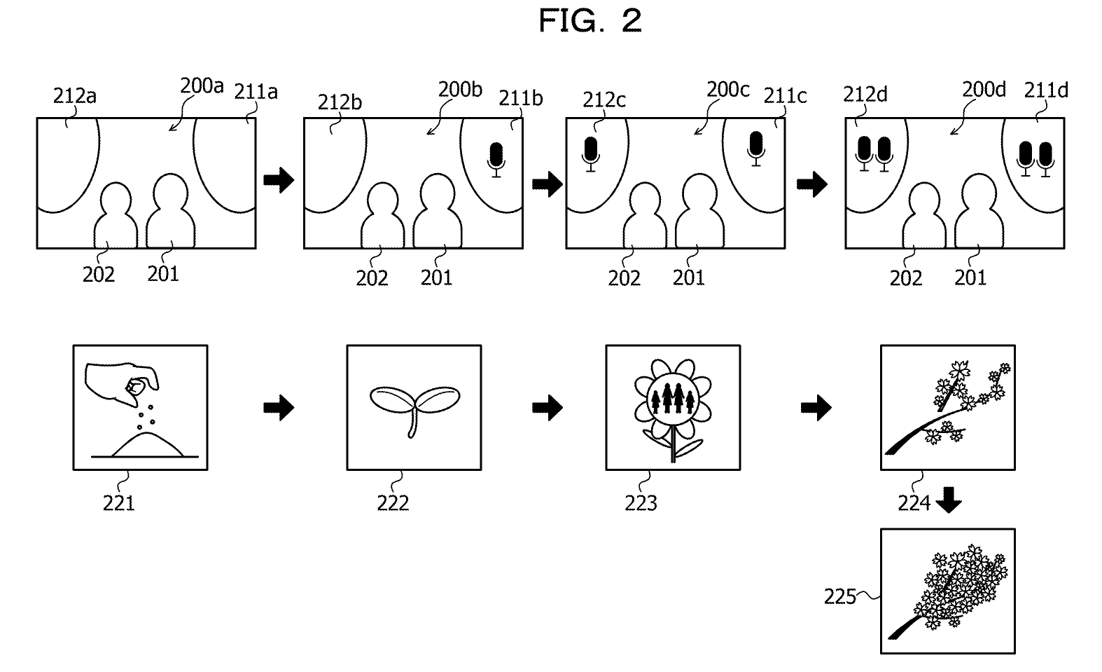

In such case, in displaying the icon 113 of the work B, a second type of mark other than the first type of mark, which indicates that the amount of sound information that satisfies the predetermined condition is not added, may be displayed. The second type of mark will be described below with reference to FIG. 2.

As described above, in displaying a list of icons of the comic content, the user terminal device 111 displays the first type of mark 122 indicating that sound information is registered. Thus, enables the user (audience, voice actor) to easily recognize whether or not sound information is added to the comic content.

FIG. 2 illustrates an example of marks that vary according to the level of addition of sound information. In FIG. 2, comic contents 200a to 200d illustrate the state where sound information is added to the same image information in time series. The image information related to the comic contents 200a to 200d includes two characters 201 and 202.

The comic content 200a is in a first phase: only image information is registered, and both of sound information corresponding to lines of the character 201 and sound information corresponding to lines of the character 202 are not added. This is also indicated by that nothing is described in a balloon 211a for the line of the character 201 and balloon 212a for the line of the character 202.

The comic content 200b is in a second phase: only sound information corresponding to lines of the character 201 is added, and sound information corresponding to lines of the character 202 is not added to the comic content 200a, that is, sound information is added, but sound information corresponding to all lines is not added. To represent this, a microphone mark is illustrated in a balloon 211b for lines of the character 201, and no mark is illustrated in a balloon 212b for lines of the character 202.

The comic content 200c is in a third phase: sound information corresponding to lines of the character 202 is added, that is, sound information corresponding to all lines is added to the comic content 200b. To represent this, a microphone mark is illustrated in both of a balloon 211c for lines of the character 201 and a balloon 212c for lines of the character 202.

The comic content 200d is in a fourth phase: another sound information corresponding to lines of the character 201 is registered, and another sound information corresponding to lines of the character 202 is added, that is, a plurality of pieces of sound information are added to the comic content 200c. To represent this, two microphone marks are illustrated in both of a balloon 211d for lines of the character 201 and a balloon 212d for lines of the character 202. In this manner, the sound information is added from the comic content 200a to the comic content 200d in time series.

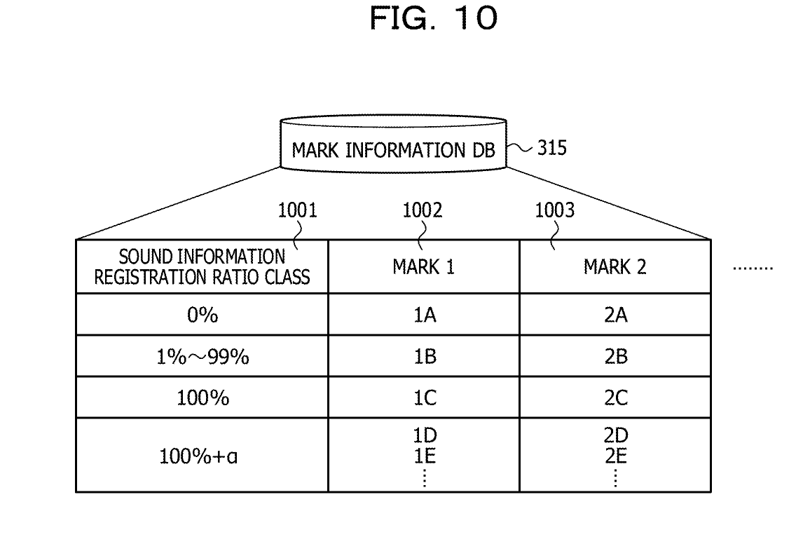

A mark 221 represents the state in the first phase of the comic content 200a. The mark 221 is a pict icon representing plant seeds (or seeding). The mark 221 represents the state in the first phase, which implies that the mark has not grown. The mark 221 corresponds to “1A” in a “mark 1” in a mark information DB 315 in FIG. 10 described below.

A mark 222 represents the state in the second phase of the comic content 200b. The mark 222 is a pict icon representing the state of germination. The mark 222 represents the state in the second phase grown from the mark 221 in the first stage. The mark 222 corresponds to “1B” in the “mark 1” in the mark information DB 315 in FIG. 10 described below.

A mark 223 represents the state in the third phase of the comic content 200c. The mark 223 is a pict icon representing the state where a flower has opened. The mark 223 represents the state in the third phase grown from the mark 222 in the second phase. The mark 223 corresponds to “1C” in the “mark 1” in the mark information DB 315 in FIG. 10 described below.

A mark 224 represents the state in the fourth phase of the comic content 200d. The mark 224 is a pict icon representing the state where a plurality of flowers have opened. The mark 224 represents the state in the fourth phase grown from the mark 223 in the third phase. The mark 224 corresponds to “1D” in the “mark 1” in the mark information DB 315 in FIG. 10 described below.

The mark 224 may be further grown. Depending on the registration level of redundant sound information for lines, as illustrated by a mark 225 representing the state in a fifth phase, pict icons representing the state where more flowers have opened may be prepared in stages, and used according to situations.

In illustrating the state of the addition of sound information in time series, by using the pict icons representing the growth process, the user may intuitively recognize the level of completeness of the comic content. The growth process may be called a process to completion. As a common opinion, especially the audience of comics and persons concerned such as producers of comics and animations may instinctively understand pictures or symbols more easily than letters. Accordingly, the user may instinctively the level of completeness of comic works by using such icons as indicators for selection.

Since the user (voice actor) may register his/her voice to change the display mode of the marks 221 to 225, the user may obtain a feeling of achievement or satisfaction that the user himself/herself tries to complete the comic work by viewing the pict icons. This may rise the voice actor's willingness to participate, promoting the participation of the voice actor. Further, the voice actors may compete with each other to upgrade their skills.

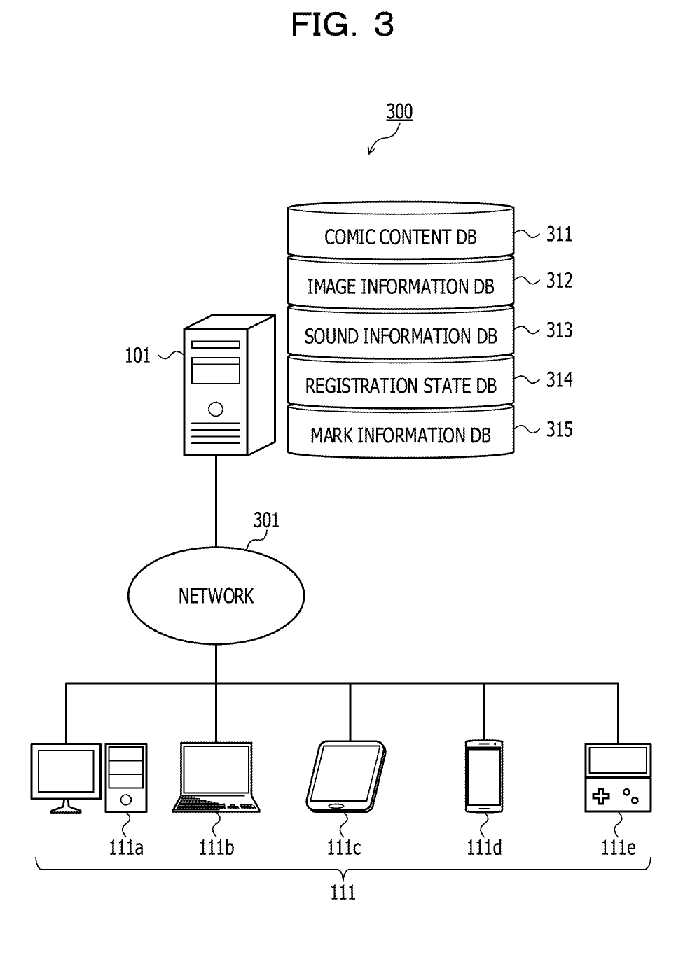

Next, an example of configuration of a comic content offering system 300 for implementing a content display program, a content display method, and a content display apparatus according to an embodiment will be described. FIG. 3 illustrates the example of the comic content offering system.

In FIG. 3, the comic content offering system 300 has the server 101 and the user terminal device 111 (user terminal devices 111a, 111b, 111c, 111d, 111e . . . ). In the comic content offering system 300, the server 101 and the user terminal device 111 are connected to each other via a wired or wireless network 301. Examples of the network 301 include the Internet, a mobile telecommunications network, a local area network (LAN), and a wide area network (WAN).

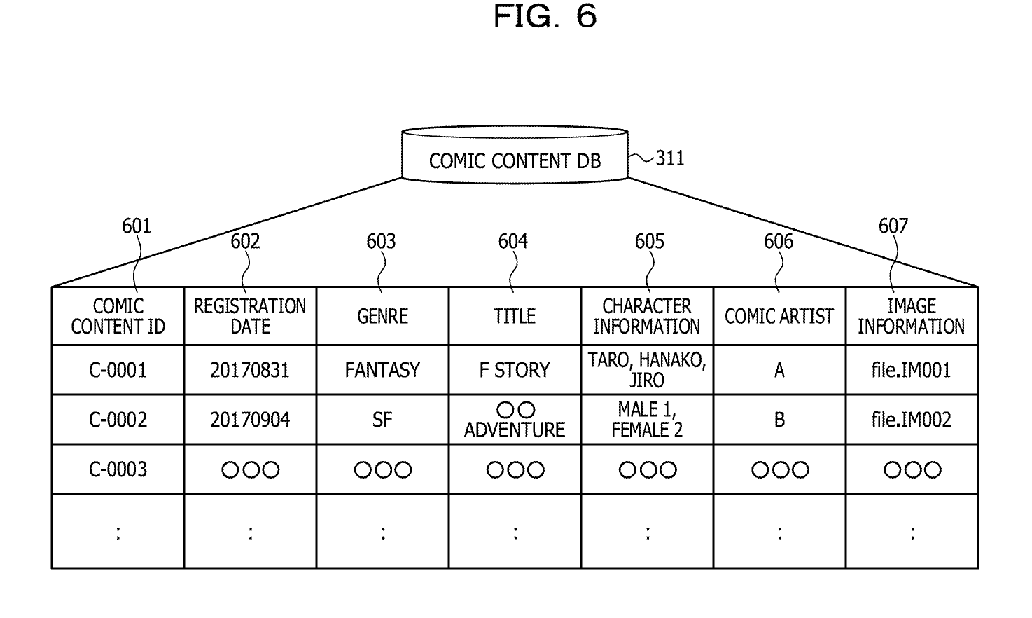

The server 101 has a comic content database (DB) 311, an image information database (DB) 312, a sound information database (DB) 313, a registration state database (DB) 314, and a mark information database (DB) 315. Contents stored in the DBs 311 to 315 will be described below with reference to FIGS. 6 to 10.

The user terminal device 111 (111a to 111e) is an information processor used by the user (voice actor) who speaks voice into comics and the user (audience) who appreciates comics. Examples of the user terminal device 111 include a desk top personal computer (PC), a notebook PC, a tablet terminal device, a smart phone, a mobile phone, home-use game equipment connected to television, and portable game equipment.

(Exemplified Hardware Configuration of Server 101)

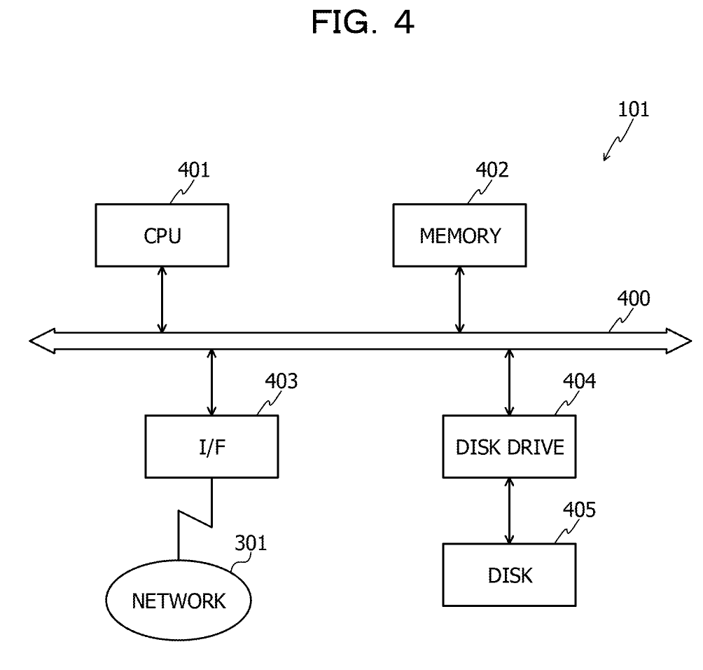

FIG. 4 illustrates an example of hardware configuration of the server. In FIG. 4, the server 101 has a central processing unit (CPU) 401, a memory 402, an interface (I/F) 403, a disc drive 404, and a disc 405. The constitutes are interconnected via a bus 400.

The CPU 401 controls the entire server 101. The memory 402 has, for example, a read only memory (ROM), a random access memory (RAM), and a flash ROM. Specifically, for example, the flash ROM and the ROM store various programs, and the RAM is used as a work area for the CPU 401. The program stored in the memory 402 are loaded into the CPU 401, allowing the CPU 401 to execute coded processing.

The I/F 403 is connected to the network 301 via a communication line, and is connected to another device (for example, the user terminal device 111 illustrated in FIG. 3) via the network 301. The I/F 403 controls an interface between the network 301 and the device itself to control input/output of data from/to another device. Examples of the I/F 403 include a modem and a LAN adaptor.

The disc drive 404 controls read/write of data from/to the disc 405 according to the control of the CPU 401. The disc 405 stores data written under the control of the disc drive 404. Examples of the disc 405 include a magnetic disc and an optical disc.

The server 101 may have, in addition to the above-described constituents, a solid state drive (SSD), a keyboard, a pointing device, and a display.

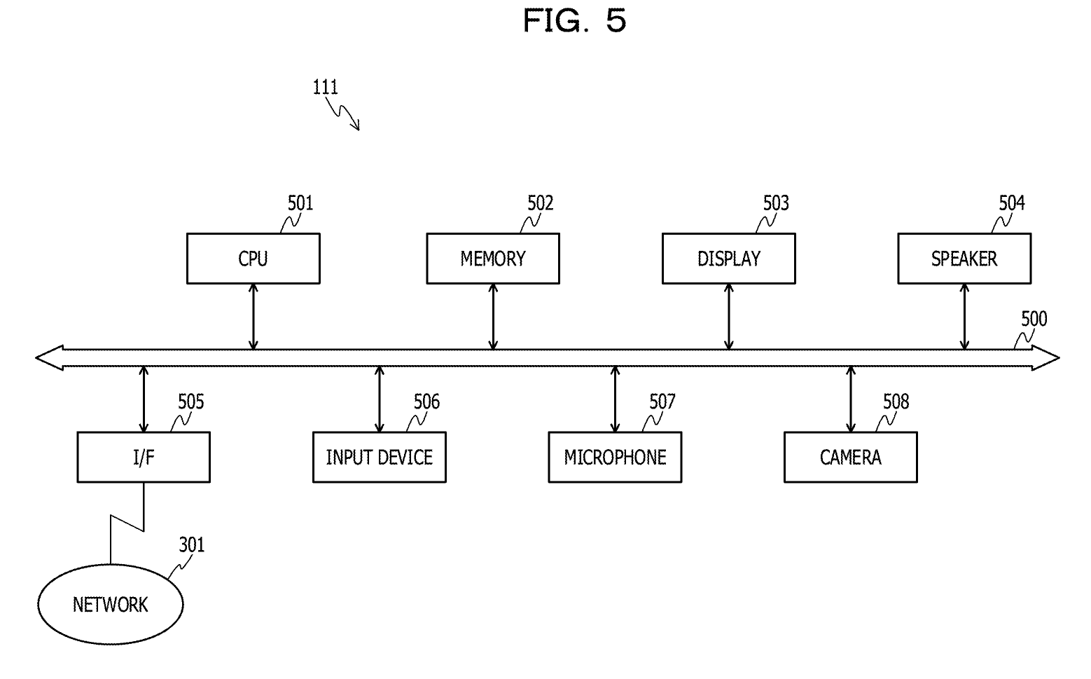

FIG. 5 illustrates an example of hardware configuration of the user terminal device. In FIG. 5, the user terminal device 111 has a CPU 501, a memory 502, a display 503, a speaker 504, an I/F 505, an input device 506, a microphone 507, and a camera 508. The constituents are interconnected via a bus 500.

The CPU 501 controls the entire user terminal device 111. The memory 502 has, for example, a ROM, a RAM, and a flash ROM. Specifically, for example, the flash ROM and the ROM store various programs, and the RAM is used as a work area for the CPU 501. The program stored in the memory 502 are loaded into the CPU 501, allowing the CPU 501 to execute coded processing.

The display 503 displays a cursor and an icon or a tool box as well as various data including documents, pictures, and functional information. Examples of the display 503 include a liquid crystal display, and an organic electroluminescence (EL) display. The display 503 may be a projector for projecting images or a head-mount display capable of reproducing 3D (three dimensions) images.

The speaker 504 is a device that generates sound based on an electrical signal. The speaker 504 outputs sound information including voice information corresponding to lines, effective sound and so on. In a stereo-type speaker capable of individually outputting sound from left and right, the left speaker may output sound for lines in a left balloon in a frame, and the right speaker may output sound for lines in a right balloon in the frame. Alternatively, the left speaker may output sound for lines of a left person in a frame, and the right speaker may output sound for lines of a right person in the frame.

A surround-type speaker may sequentially output sound for lines in balloons from one to the other (from right to left, from left to right, from top to bottom, from bottom to top, from back to front, and from front to back). Thus, such information may be included in the sound information offered from the user.

By devising how to output sound in this manner, a sense of realism of sound may be added to the comic work based on static images to offer a new type of entertainment to the user (audience).

The I/F 505 is connected to the network 301 via a communication line, and is connected to another device (for example, the server 101 illustrated in FIG. 3) via the network 301. The I/F 505 controls an interface between the network 301 and the device itself to control input/output of data from/to another device.

The input device 506 has keys for inputting characters, figures, and various instructions, and inputs data. Examples of the input device 506 include a keyboard and a pointing device (a mouse, a joy stick, or the like). The input device 506 may be a touch panel-type input pad or numeric key.

The touch panel is a combination of a sensor for detecting tapping and flicking operations of the user and a display for displaying a cursor and an icon or a tool box as well as various data including documents, pictures, and functional information. Specifically, the sensor is disposed on the display. Examples of the sensor include a resistive film type sensor, and a surface-mounted or projecting electrostatic type sensor. This enables both of key inputting and handwriting inputting of letters and so forth.

The microphone 507 converts sound into an electrical signal. The microphone 507 may be used when the voice actor records voice data corresponding to lines. The microphone 507 may be also used when the audience issues a verbal instruction (specifically, for example, selection of a comic work, turning pages).

The camera 508 takes static images and dynamic images. The camera 508 may take images of a comic work. In addition to or in place of the camera 508, a scanner may read images of the comic work. The camera or the scanner may have an optical character recognition (OCR) function, and extract and recognize text information from images.

The user terminal device 111 may have, in addition to the above-described constituents, a hard disk drive (HDD) and an SSD. An acceleration sensor or a gyro sensor may be used as the input device 506 to input information related to direction and inclination.

The DBs 311 to 315 each may be embodied as a storage device such as the memory 402 and the disc 405 of the server 101 in FIG. 4. The DBs 311 to 315 may be connected via the I/F 403 of the server 101.

FIG. 6 illustrates an example of contents of the comic content. As illustrated in FIG. 6, the comic content DB 311 has following item columns (columns): a “comic content identification (ID)” column 601, a “registration date” column 602, a “genre” column 603, a “title” column 604, a “character information” column 605, a “comic artist” column 606, and “image information” column 607. Information is stored in a field formed of each item column, such that the comic content is registered as a record.

The “comic content ID” column 601 stores the comic content ID, that is, a unique ID assigned to a new comic content. The “registration date” column 602 stores information on the registration date of the concerned comic content. Only date or date and time may be stored in the “registration date” column 602. The “genre” column 603 stores information on genre of the concerned comic content. An example of the genre is the type of works classified according to contents of comics, such as “fantasy”, “science fiction (SF)”, “gag”, and “sports”.

The “title” column 604 stores information on the title (heading) of the concerned comic content. The “title” column 604 may store information on the subtitle and the issue number of a serialization. The “character information” column 605 stores information on the characters appearing in the concerned comic content. Specifically, for example, the total number of characters and a name of each character are stored. Descriptions of the characters (for example, male, female, leading role, and supporting role, and character personality) may be stored. The character names may be used to classify lines of each character.

The “comic artist” column 606 stores the provider (creator) name of the concerned comic content. The provider name may be a real name, a pen name, or a handle name. The “image information” column 607 stores image information of the concerned comic content. The image information is stored as image data in the predetermined file form (for example, “JPEG”, “GIF”, and “PNG”).

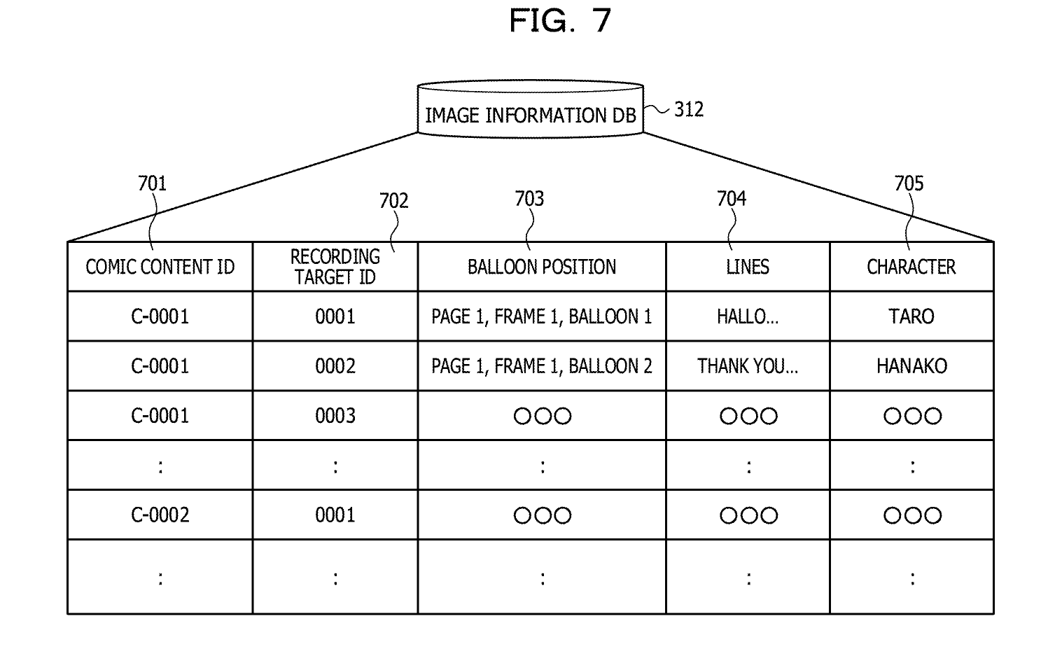

FIG. 7 illustrates an example of stored contents of image information. As illustrated in FIG. 7, the image information DB 312 includes item columns (columns): a “comic content ID” column 701, a “record target ID” column 702, a “balloon position” column 703, a “lines” column 704, and a “character” column 705. Information is stored in a field formed of each item column, such that information related to the image information is registered as a record.

The “comic content ID” column 701 stores the same information (comic content ID) as the information stored in the “comic content ID” column 601 of the comic content DB 311 in FIG. 6. Accordingly, the comic content DB 311 and the image information DB 312 may associate their records with each other according to the “comic content ID”.

The “record target ID” column 702 stores the unique ID assigned to sound information corresponding to the lines of the record target ID, that is, the concerned comic content (or effective sound or background sound if present). Accordingly, the same number of record targets ID as the number of lines (or the number of effective sounds or background sounds if present) in the concerned comic content are assigned.

The “balloon position” column 703 stores information on the position of the balloon in which lines of the concerned record target ID are described. For example, a page number, a frame number, or a balloon number if a plurality of balloons are present in one frame is stored. When only frames are continuously arranged in electronic comic contents and pages as in paper comic contents are not present, only the frame number and the balloon number may be stored. In any case, the “balloon position” column 703 only has to store information that identify the position of the balloon in the concerned comic content.

The “lines” column 704 stores information on contents of lines of the concerned record target ID. The information on contents of lines may include text information; fonts, size, color of letters; vertical/horizontal writing; and line feeds. The “character” column 705 stores information on the character who speaks lines related to the concerned record target ID.

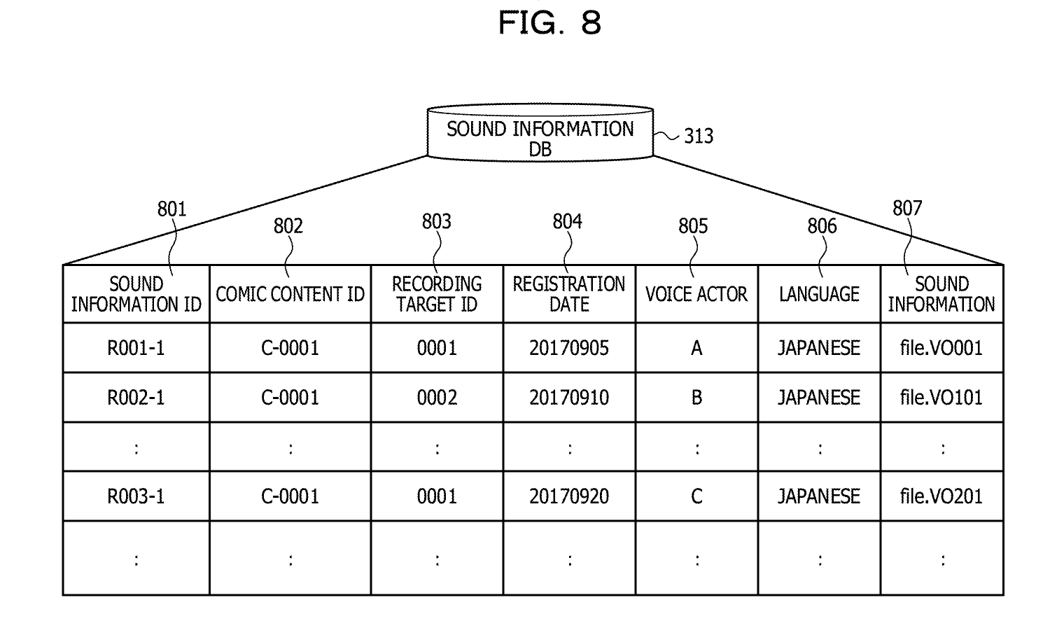

FIG. 8 illustrates an example of contents of sound information. As illustrated in FIG. 8, the sound information DB 313 has item columns (columns): a “sound information ID” column 801, a “comic content ID” column 802, a “record target ID” column 803, a “registration date” column 804, a “voice actor” column 805, a “language” column 806, and a “sound information” column 807. Information is stored in a field formed of each item column, such that information related to the sound information is registered as a record.

The “sound information ID” column 801 stores the record target ID, that is, a unique ID assigned to sound information recorded for each line (or each effective sound or each background sound if present) of the concerned comic content.

The “comic content ID” column 802 stores the same information (comic content ID) as the information stored in the “comic content ID” column 601 of the comic content DB 311 in FIG. 6 and in the “comic content ID” column 701 of the image information DB 312 in FIG. 7. The “record target ID” column 803 stores the same information (record target ID) as the information stored in the “record target ID” column 702 of the image information DB 312 in FIG. 7. Accordingly, each record in the sound information DB 313 may be associated with each record in the comic content DB 311 according to the “comic content ID”, and may be associated with each record in the image information DB 312 according to the “comic content ID” and the “record target ID”.

Like the “registration date” column 602 of the comic content DB 311 in FIG. 6, the “registration date” column 804 stores information on the registration date of the concerned sound information. The “registration date” column 804 may store only date or date and time.

The “voice actor” column 805 stores a provider (voice actor) name of the concerned sound information. The provider (voice actor) name may be a real name, a stage name, or a handle name. Although not illustrated, information distinguishing a professional voice actor from an armature voice actor may be stored. Information on profile of the voice actor (for example, history and previous registered works) may be also stored.

When the concerned sound information is voice information, the “language” column 806 stores information on the language. The sound information may include voice information in the language, and in this case, the sound information may include information on the type of language. Examples of the type of language include Japanese, English, Chinese, German, French, and Korean, and Japanese dialects such as Kansai accent, Tohoku accent, and Kyushu accent.

The “language” column 806 may store, in addition to the information on language, although not illustrated, information on a mark that varies according to the type of language (for example, a national flag of a country using the language). Alternatively, information on the mark that varies according to the type of language may be associated with the information in the “language” column 806, and stored.

The “sound information” column 807 stores the concerned sound information. For example, the sound information is natural voice data of lines spoken by the voice actor. The sound information may be processed natural voice data (voice data echoed or modified using a voice changer), or artificial voice data. The sound information is stored in a predetermined file format (for example, “WAV”, “AIFF”, and “mp3”).

Although not illustrated, sound information corresponding to a set of lines is registered as a sound data set, the sound information DB 313 in FIG. 8 may store the set information. Thereby, registered sound information may be easily extracted in unit of set.

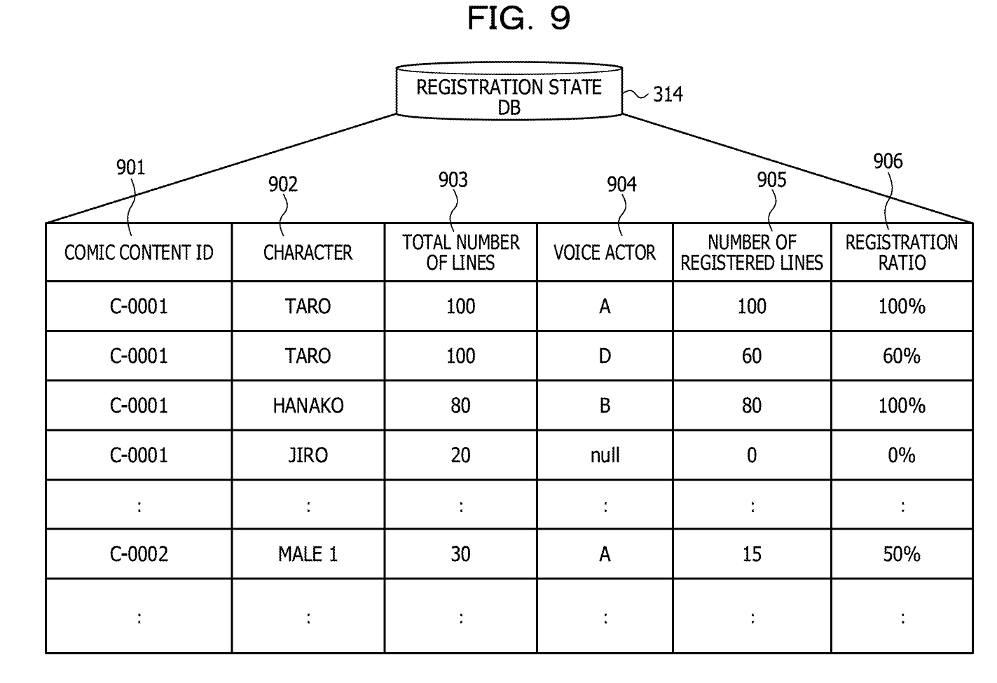

FIG. 9 illustrates an example of stored contents of the registration state. As illustrated in FIG. 9, the registration state DB 314 has item columns (columns): a “comic content ID” column 901, a “character” column 902, a “total number of lines” column 903, a “voice actor” column 904, a “number of registered lines” column 905, and a “registration ratio” column 906. Information is stored in a field formed of each item column, such that information related to the sound information is registered as a record.

The “comic content ID” column 901 stores the same information (comic content ID) as the information stored in the “comic content ID” column 601 of the comic content DB 311 in FIG. 6, the “comic content ID” column 701 of the image information DB 312 in FIG. 7, and the “comic content ID” column 802 of the sound information DB 313 in FIG. 8.

The “character” column 902 stores characters appearing in the concerned comic content. Different characters are stored as different records. Irrespective of whether or not sound information is registered, records for the characters appearing in the concerned comic content are created.

The “total number of lines” column 903 stores information on the total number of lines of the characters in the concerned comic content in the “character” column 902 of the same record. Accordingly, the total number of all lines in the concerned comic content is a sum of the lines of the characters in the “total number of lines” column 903. For example, when the characters are three persons of “Taro”, “Hanako”, and “Jiro”, and the total number of lines of the character “Taro” is “100”, the total number of lines of the character “Hanako” is “80”, and the total number of lines of the character “Jiro” is “20”, the total number of all lines in the concerned comic content is “200”.

The “voice actor” column 904 stores the voice actor who registers lines of the concerned character. The voice actors of the same character having the same comic content ID are stored as different records. When a character with no sound information recorded is present, the “voice actor” column 904 in the record of the character becomes “null”.

The “number of registered lines” column 905 stores information on the number of lines of the concerned character in the concerned comic content, which is registered by the concerned voice actor. In the record of the record including “null” in the “voice actor” column 904, the “number of registered lines” column 905 becomes “0”.

The “registration ratio” column 906 stores information on the registration ratio of lines of the concerned character in the concerned comic content, which are registered by the concerned voice actor. The registration ratio is a value acquired by dividing the number of registered lines in the “number of registered lines” column 905 by the total number of lines in the “total number of lines” column 903. In the record having “0” in the “number of registered lines” column 905, “0 (%)” is registered in the “registration ratio” column 906.

FIG. 10 illustrates an example of contents of mark information. As illustrated in FIG. 10, the mark information DB 315 has item columns (columns): a “registration ratio class” column 1001, a “mark 1” column 1002, and a “mark 2” column 1003. The information is stored in a field formed of each item column, such that information related to the sound information is registered as a record.

The “registration ratio class” column 1001 stores the registration ratio class (registration ratio range) stored in the “registration ratio” column 906 of the registration state DB 314 in FIG. 9. When the sound information registration ratio class is “0%”, “1A” is associated with the mark 1. That the sound information registration ratio class is “0%” indicates that no sound information is registered, that is, comic content includes only image information.

When the sound information registration ratio class is “1% to 99%”, “1B” is associated with the mark 1. That the sound information registration ratio class is “1% to 99%” indicates that sound information for one or more lines is registered in at least comic content, sound information for all lines is not registered, and sound information for at least one or more lines is not registered.

When the sound information registration ratio class is “100%”, “1C” is associated with the mark 1, and when the sound information registration ratio class is “100%+a”, “1D”, “1E” . . . are associated with the mark 1. That the sound information registration ratio class is “100%” indicates that sound information for all lines is registered. When a plurality of voice actors redundantly register sound information for lines of the same character, the associated mark varies to “1D”, “1E” . . . according to a multiplicity “α”. In this manner, a plurality of different types of marks corresponding to the multiplicity of the added sound information (voice information) may be prepared.

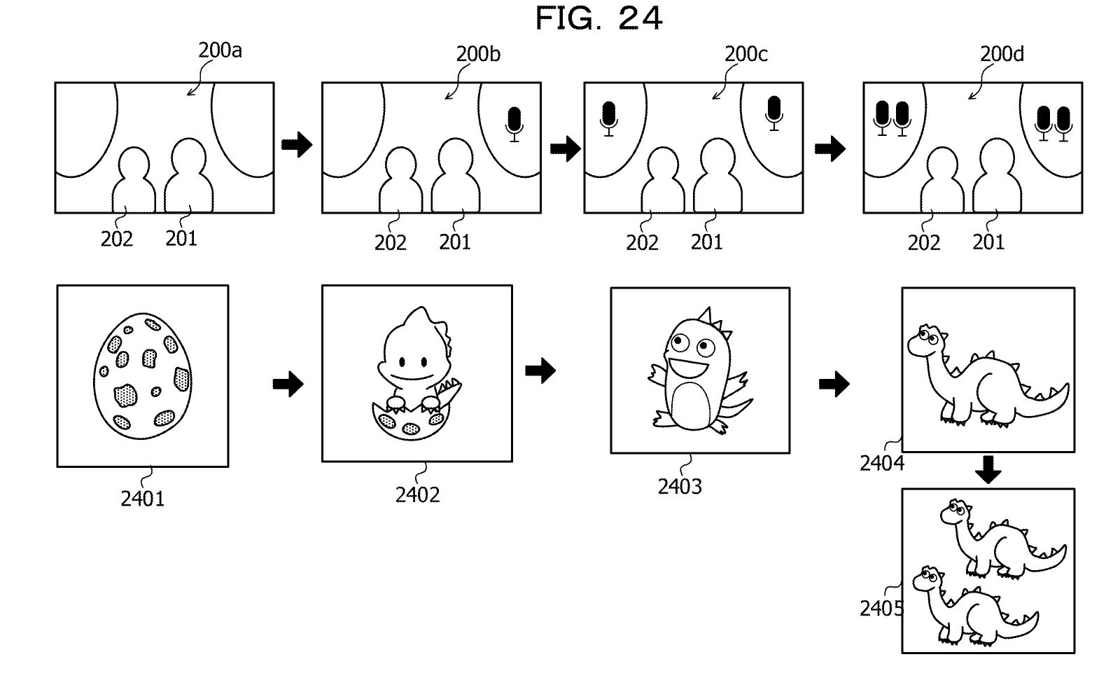

The “mark 1” column 1002 and the “mark 2” column 1003 store image data of different icons (for example, below-mentioned pict icons) as marks. For example, the mark 1 is plant (see FIG. 2), and the mark 2 is dinosaur (see below-mentioned FIG. 24). The “mark 1” or the “mark 2” is selected according to an instruction. Although not illustrated, marks other than the “mark 1” and the “mark 2” (“mark 3”, “mark 4” . . . ) may be provided.

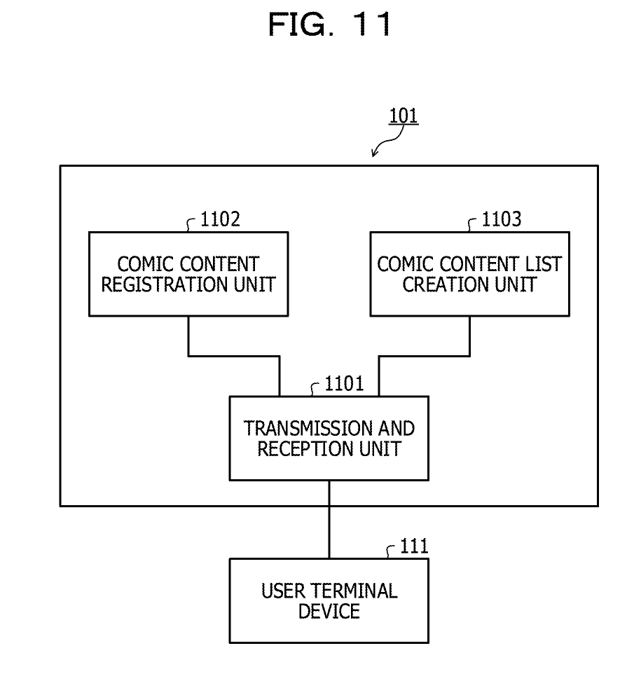

FIG. 11 illustrates an example of a functional configuration of the server. In FIG. 11, the server 101 includes a transmission and reception unit 1101, a comic content registration unit 1102, and a comic content list creation unit 1103.

The transmission and reception unit 1101 receives various information transmitted from the user terminal device 111 via the network 301. The transmission and reception unit 1101 transmits various information to the user terminal device 111 via the network 301. Specifically, for example, the transmission and reception unit 1101 may perform its function by using the I/F 403 in FIG. 4 or by causing the CPU 401 to run a program stored in storage devices such as the memory 402 and the disc 405.

The comic content registration unit 1102 registers the comic content that is transmitted from the user terminal device 111 and received by the transmission and reception unit 1101. Specifically, the comic content registration unit 1102 receives image information in the comic content from the transmission and reception unit 1101, and registers the image information in the comic content DB 311 and the image information DB 312. The comic content registration unit 1102 receives sound information in the comic content from the transmission and reception unit 1101, and registers the sound information in the sound information DB 313. Specifically, for example, the comic content registration unit 1102 perform its function by causing the CPU 401 to run a program stored in storage devices such as the memory 402 and the disc 405 in FIG. 4, or by using the I/F 403.

When registering the image information, the comic content registration unit 1102 assigns the comic content ID, associates the concerned comic content ID with the concerned image information, and stores the image information in the comic content DB 311 and the image information DB 312. When registering the image information, the comic content registration unit 1102 assigns the record target ID to each line, associates the concerned record target ID with the concerned image information, and stores the image information in the comic content DB 311 and the image information DB 312. When registering the sound information, the comic content registration unit 1102 assigns the sound information ID to each sound information registered for each line (or each effective sound or background sound, if present) in the concerned comic content, and stores the concerned sound information ID in the sound information DB 313.

The comic content list creation unit 1103 creates a list of displayable comic contents (that is, comic contents that may be offered to the user terminal device 111 and be appreciated on the user terminal device 111). Specifically, for example, the comic content list creation unit 1103 performs the function by causing the CPU 401 to run a program stored in storage devices such as the memory 402 and the disc 405 in FIG. 4. The comic content list created by the comic content list creation unit 1103 is transmitted from the transmission and reception unit 1101 to the user terminal device 111.

In creating the list of displayable comic contents, when an amount of sound information that satisfies the predetermined condition is added to the comic content, the comic content list creation unit 1103 associates a first type of mark (for example, the mark 223 in FIG. 2) to the concerned comic content. When the amount of sound information that satisfies the predetermined condition is not added, the first type of mark is not associated with the concerned comic content.

When the amount of sound information that satisfies the predetermined condition is not added, the comic content list creation unit 1103 does not associate the first type of mark with the concerned comic content, or may associate a second type of mark other than the first type of mark, which indicating that the amount of sound information that satisfies the predetermined condition is not added, with the concerned comic content.

For example, the predetermined condition may be that, when sound information is voice information on lines of the character in the comic content, whether or not a ratio of the number of lines with voice information to the total number of lines in the comic content exceeds a predetermined ratio. The predetermined ratio may be expressed as less than 1%, 15% or less, 30% or more, more than 60%, 100%, ⅓ or less, a majority, or any similar expression (numerical value).

For example, as illustrated in a mark information DB 315 in FIG. 10, when the registration ratio is 100%, it may be determined that the predetermined condition is satisfied to select the first type of mark “1C”, and when the registration ratio is less than 100%, it may be determined that the predetermined condition is not satisfied so as not to select the mark “1C”.

Alternatively, when the registration ratio is less than 100%, it may be determined that the predetermined condition is not satisfied to select the second type of mark “1A” or “1B”. That is, the second type of mark may consist of a plurality of different types of marks (for example, the mark 221 and the mark 222 in FIG. 2) corresponding to the number of lines with voice information in the total number of lines in the concerned comic content. The second type of mark consisting of the plurality of different types of marks (for example, the mark 221 and the mark 222) may be a mark indicating process of growing as the number of lines with voice information in the total number of lines increases, as described with reference to FIG. 2.

The second type of mark consisting of the plurality of different types of marks may be a mark indicating that the level of completeness becomes higher as the number of lines with voice information in the total number of lines increases. Details of the mark that gradually becomes higher in the level of completeness will be described below with reference to FIG. 24.

The first type of mark may also consist of a plurality of different types of marks (for example, the mark 224 and the mark 225 in FIG. 2) corresponding to the multiplicity of voice information added in the comic content.

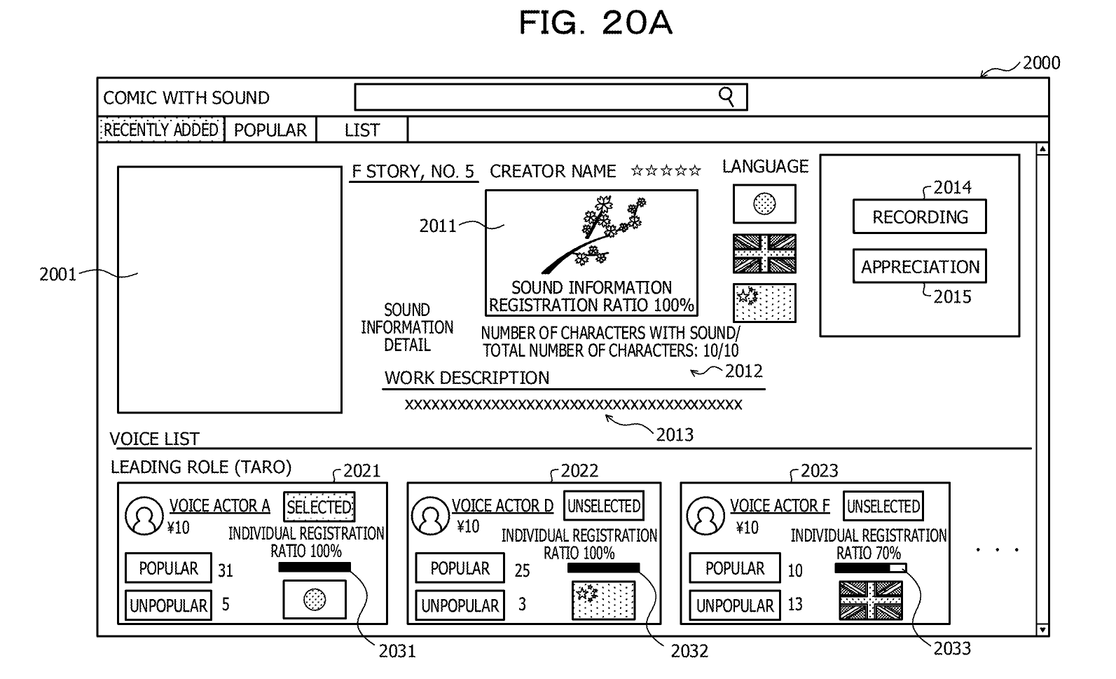

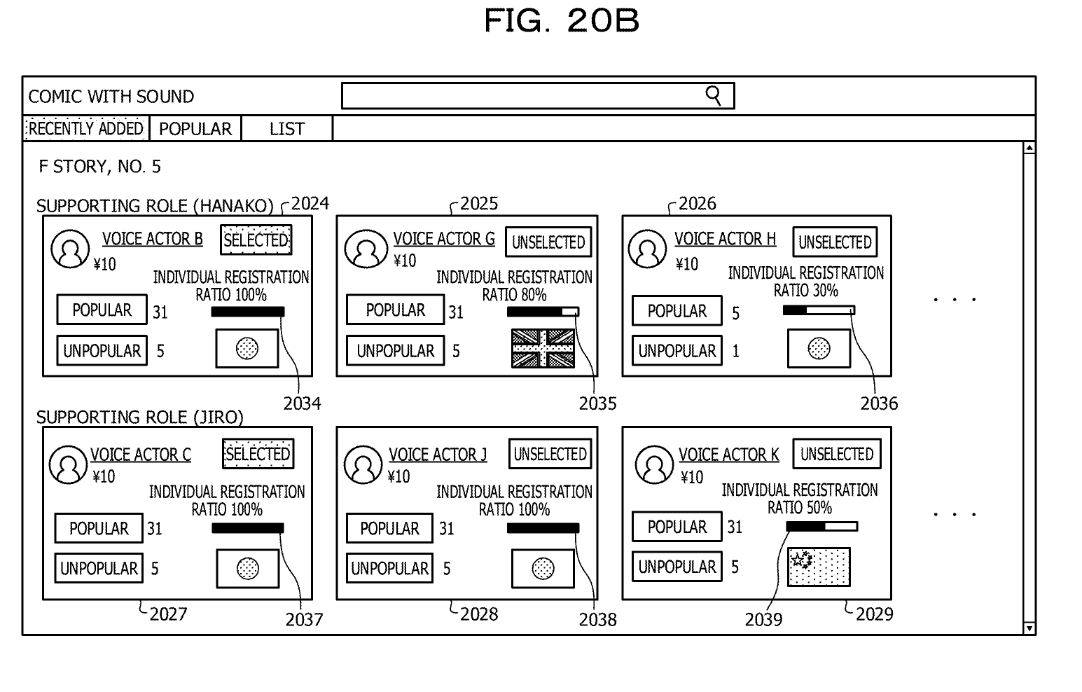

When creating a comic content list, the comic content list creation unit 1103 may associate information on the total number of characters in the concerned comic content and information on the number of characters having all lines to which voice information is added in all characters in the concerned comic content, with the concerned comic content. The information on the total number of characters and the information on the number of characters having all lines to which voice information is added will be described below with reference to FIG. 20A.

When creating the comic content list, the comic content list creation unit 1103 may associate a mark that vary according to a ratio of the number of lines with voice information to the total number of lines for each character in the concerned comic content, with the concerned comic content. The mark that varies according to the ratio of the number of lines with voice information to the total number of lines for the concerned character may consist of a graph indicating the ratio (for example, a bar graph, a pie graph). The mark (graph) that varies according to the ratio of the number of lines with voice information to the total number of lines for the concerned character will be described below with reference to FIGS. 20A and 20B.

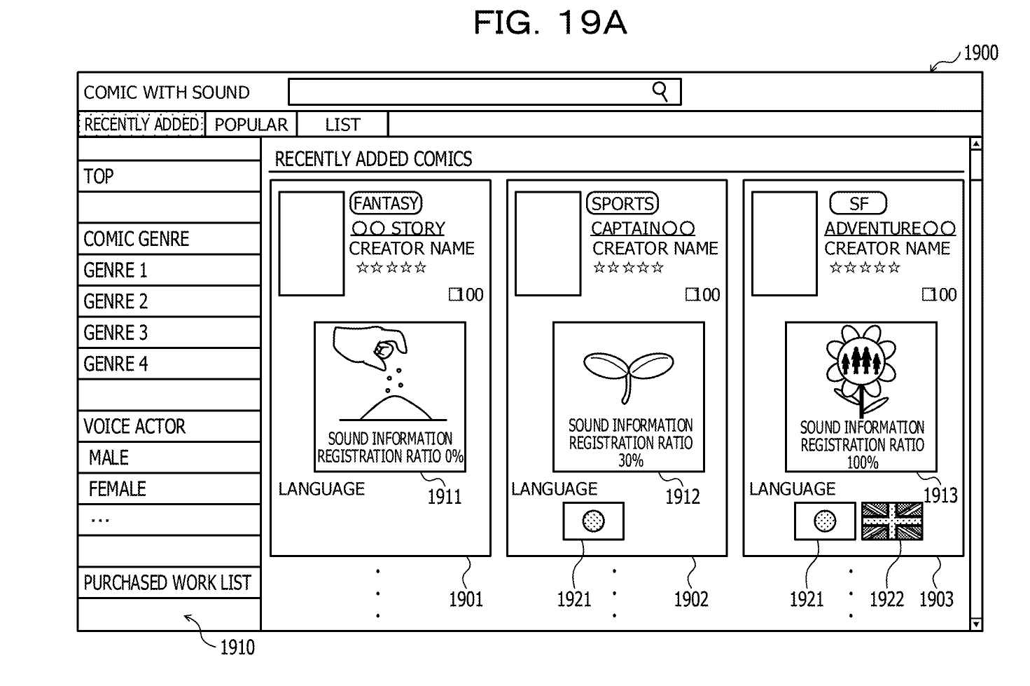

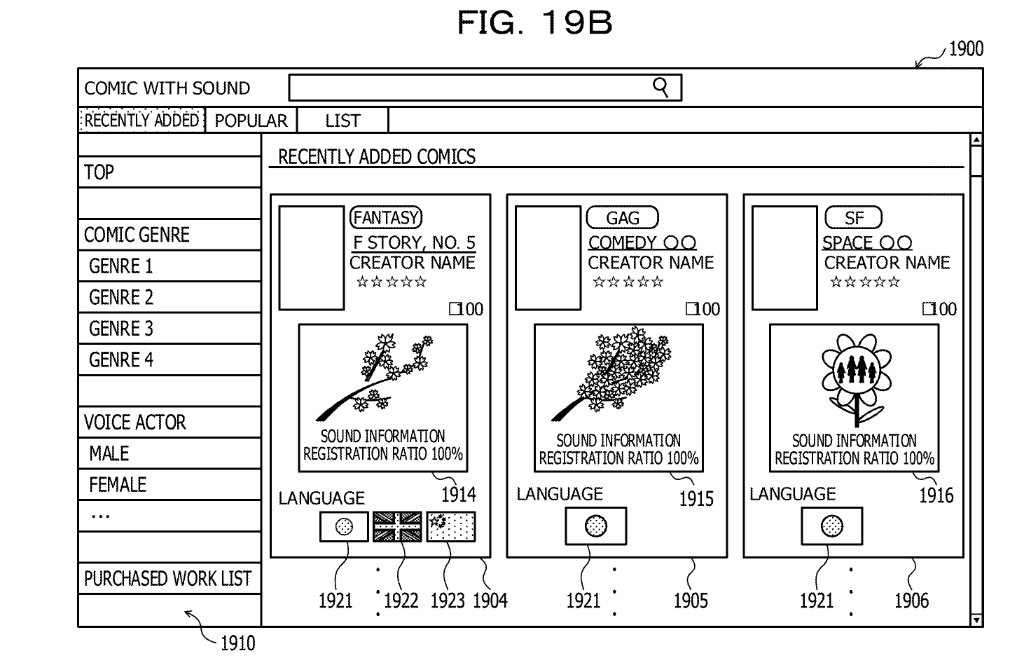

In this manner, the comic content list creation unit 1103 creates a comic content list. Specific contents of the comic content list will be described below with reference to FIGS. 19A to FIG. 20B. Information on the comic content list created by the comic content list creation unit 1103 is received by the transmission and reception unit 1101 and then, is transmitted to the user terminal device 111 that makes a request of the comic content list via the network 301.

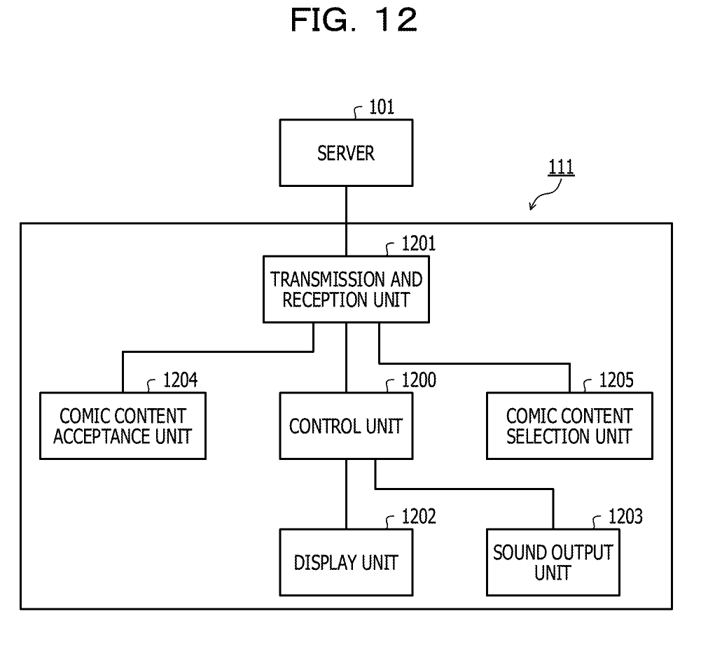

FIG. 12 illustrates an example of a functional configuration of the user terminal device. In FIG. 12, the user terminal device 111 includes a control unit 1200, a transmission and reception unit 1201, a display screen 1202, a sound output unit 1203, a comic content acceptance unit 1204, and a comic content selection unit 1205.

The control unit 1200 controls the display screen 1202 and the sound output unit 1203 to control contents displayed on the display screen 1202 and sound outputted from the sound output unit 1203. Specifically, for example, the control unit 1200 may perform the function by causing the CPU 501 to run a program stored in a storage device such as the memory 502 in FIG. 5, or by using the I/F 505. Specifically, for example, the display screen 1202 may perform the function by using the display 503 in FIG. 5. Specifically, for example, the sound output unit 1203 may perform the function by using the speaker 504 in FIG. 5.

The transmission and reception unit 1201 receives various information from the server 101 via the network 301. The transmission and reception unit 1201 transmits the various information to the server 101 via the network 301. Specifically, for example, the transmission and reception unit 1201 performs the function by using the I/F 505 in FIG. 5 or by causing the CPU 501 to run a program stored in a storage device such as the memory 502 in FIG.

5.

The control unit 1200 displays the various information received by the transmission and reception unit 1201 from the server. Thereby, the control unit 1200 displays a list of displayable comic contents. At this time, the amount of sound information that satisfies a predetermined condition (for example, whether or not a ratio of the number of lines with voice information to the total number of lines content exceeds a predetermined ratio) is added to a content, a first type of mark indicating that the concerned content is viewable with sound information may be associated with the concerned content. When the amount of sound information that satisfies the predetermined condition is not added to the content, the control unit 1200 does not associate the first type of mark with the concerned content.

The comic content acceptance unit 1204 accepts registration (posting) of a comic content from the user, and passes information on the accepted comic content (image information from the comic artist, sound information from the voice actor) to the transmission and reception unit 1201. Thereby, the user may register the comic content (image information, sound information), and offer the comic content to another user for viewing (appreciation). Specifically, for example, the comic content acceptance unit 1204 performs the function by using the input device 506, the microphone 507, and the camera 508 in FIG. 5, or by causing the CPU 501 to run a program stored in a storage device such as the memory 502.

The comic content selection unit 1205 accepts an instruction to select a comic content (image information, sound information) from the comic content list according to the user's selection, and passes the accepted instruction to the transmission and reception unit 1201. Thereby, the user may view (appreciate) the desired comic content (image information, sound information). The user may also register (post) created (recorded) sound information to the desired comic content (image information). Specifically, for example, the comic content selection unit 1205 performs the function by using the input device 506, the microphone 507, and the camera 508 in FIG. 5, or by causing the CPU 501 to run a program stored in a storage device such as the memory 502.

The control unit 1200 reproduces the comic content selected from the comic content list based on information received by the transmission and reception unit 1201. Specifically, a frame in the comic content is displayed on the display screen 1202. In the state where the frame is displayed, according to the operation for the balloon included in the frame, voice corresponding to the balloon among voices included in each of the selected sound data sets is outputted (generated) from the sound output unit 1203. Examples of the operation for the balloon include click, tap, and mouse-over.

At appreciation, when an image and sound information of a comic are outputted, the control unit 1200 may display original lines of the comic, or display lines translated into another language. For example, when sound information in Japanese is added to an original comic written in English, lines translated into English may be displayed and the sound information in Japanese may be outputted. Alternatively, the lines written in English (original) may be displayed as they are, and the sound information in Japanese may be outputted.

In this manner, the voice actor may add translated sound information uniquely arranged from the image of image information of the comic without being restricted by the lines written in Japanese, to have a greater flexibility in the comic contents. This may add sound information having a completely different meaning from the original lines, and parodies the work.

For a comic written in English, lines written in Japanese may be displayed and sound information in English (original) may be outputted. As a result, the image of the original work written in English may be changed by Japanese of the voice actor. However, the change in image may be suppressed while correctly conveying the contents to remain the atmosphere of the original work. Like sound information, translation of text of lines may be registered (posted) by the user. Thereby, in the comic content offering system 300, a professional or armature translator may participate as the user.

When the user appreciates a work, language of a line image to be displayed may be selected, the line image may not be displayed, or the line image may be freely set according to the user's preference. This enables displaying the line image according to the user's preference, to add variation to how to appreciate (enjoy) comic works.

The sound information may include, in addition to lines of characters in a work to be displayed, background music or effective sound of the work to be displayed. The lines are, for example, words corresponding to the balloon displayed in each frame of a comic. The effective sound may be imitative sound (such as “Dokken”) displayed in each frame in the comic, and may further include vehicle sound, cheers and so on. The background music may be a musical piece corresponding to each scene, a plurality of consecutive frames, or each frame. The musical piece may be an existing musical piece or an original music piece.

Places where lines and effective sound such as imitative sound to be recorded are added may be identified by image analysis of the comic content acceptance unit 1204 or the server 101. The user such as the comic artist or the voice actor, or the administrator of the comic content offering system 300 may also set the places. The user such as the comic artist or the voice actor, or the administrator of the comic content offering system 300 may set the places where the background music to be recorded is added, for each scene (every consecutive frames). Alternatively, another dedicated user may identify the places where lines and effective sound such as imitative sound are added, and perform registration (posting).

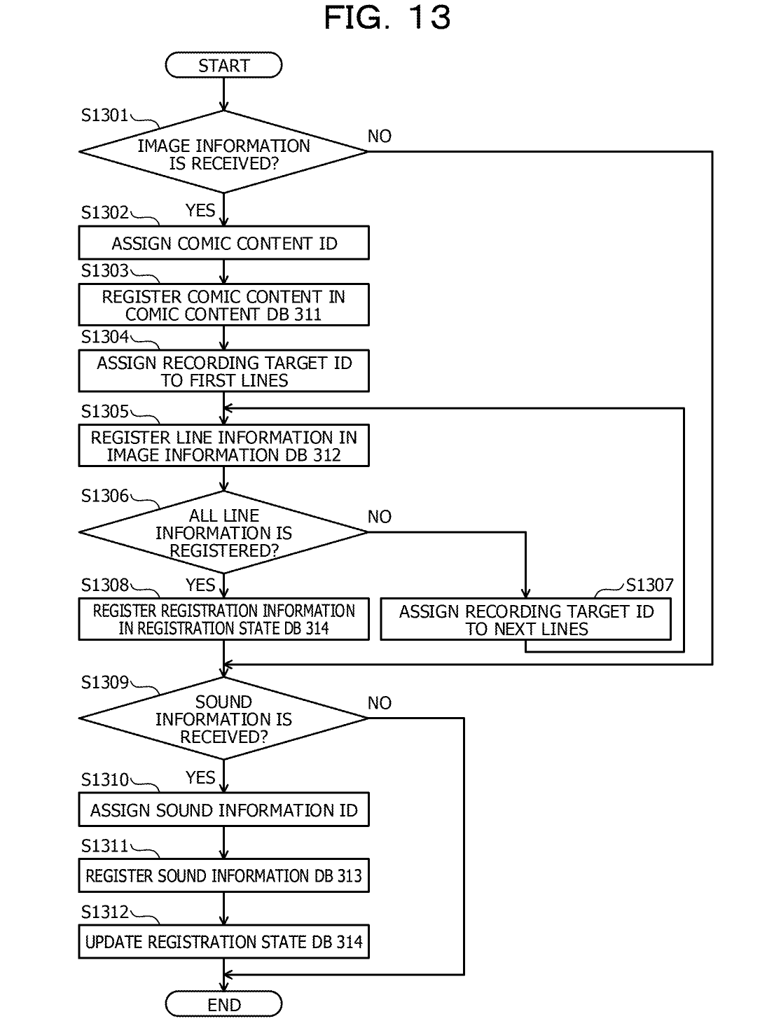

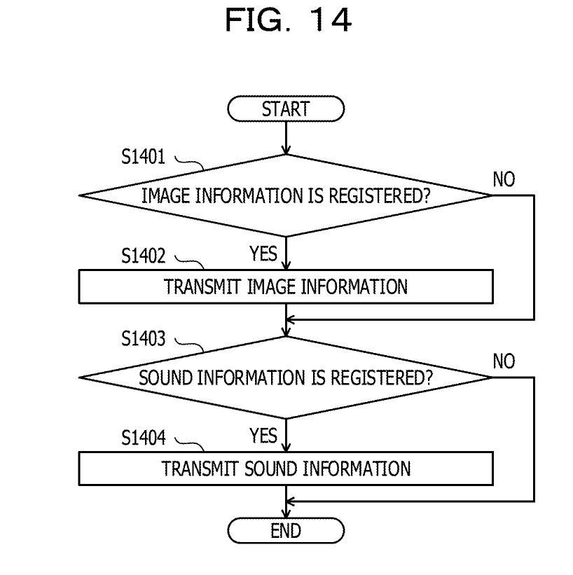

FIG. 13 illustrates an example of registration processing of the comic content to the server. FIG. 14 illustrates an example of registration acceptance processing of the comic content of the user terminal device.

In a flow chart in FIG. 13, first, the server 101 determines whether or not image information (and information related to the concerned image information) is received from the user terminal device 111 of the user (for example, comic artist) (Step S1301). When the image information is not received (Step S1301: No), the procedure proceeds to Step S1309. On the contrary, when the image information is received (Step S1301: Yes), the comic content ID is assigned to the received image information (Step S1302). The comic content is registered in the comic content DB 311 in FIG. 6 (Step S1303).

For example, the assigned comic content ID is stored in the “comic content ID” column 601 of the comic content DB 311. The current date at registration (or reception) is stored in the “registration date” column 602. Information on genre, information on title, information on character, and information on comic artist, which are included in information related to the image information are stored in the “genre” column 603, the “title” column 604, the “character information” column 605, and the “comic artist” column 606. A unique file number is assigned to the image information, and the image information is stored in the “image information” column 607.

Next, the record target ID is assigned to the first lines of the image information (Step S1304). Line information is registered in the image information DB 312 illustrated in FIG. 7 (Step S1305). Specifically, information on the balloon position, information on lines corresponding to the concerned balloon position, and information on character, which are included in information related to the image information, are stored in the “balloon position” column 703, the “lines” column 704, and the “character” column 705 of the image information DB 312, respectively.

Then, it is determined whether or not information on all lines is registered (Step S1306). When information on all lines is not registered (Step S1306: No), the record target ID is assigned to next lines (Step S1307). The procedure returns to Step S1305, and Steps S1305 to S1307 are repeated.

On the contrary, when information on all lines is registered (Step S1306: Yes), information on the registration state is registered in the registration state DB 314 in FIG. 9 (Step S1308). Specifically, for example, for each character, the comic content ID is stored in the “comic content ID” column 901 of the registration state DB 314, the character is stored in the “character” column 902, and the total number of lines of each character included in information related to the image information is stored in the “total number of lines” column 903 of the registration state DB 314. “null” is set in the “voice actor” column 904. Then, the procedure proceeds to Step S1309.

In Step S1309, the server 101 determines whether or not sound information (and information related to the concerned sound information) is received from the user terminal device 111 of the user (for example, voice actor). When the sound information is not received (Step S1309: No), a series of processing is finished. On the contrary, when the sound information is received (Step S1309: Yes), the sound information ID is assigned to the received sound information (Step S1310).

Sound information is registered in the sound information DB 313 illustrated in FIG. 8 (Step S1311). Specifically, the assigned sound information ID is stored in the “sound information ID” column 801 of the sound information DB 313. The comic content ID information included in information related to the sound information is stored in the “comic content ID” column 802. The record target ID information included in the information related to the sound information is stored in the “record target ID” column 803. The current date at registration (or reception) is stored in the “registration date” column 804. Information on voice actor and information on language, which are included in the information related to the sound information, are stored in the “voice actor” column 805 and the “language” column 806, respectively. A unique file number is assigned to the sound information, and is stored in the “sound information” column 807.

The registration state DB 314 illustrated in FIG. 9 is updated (Step S1312). Specifically, for example, information on voice actor is stored in the “voice actor” column 904 of the registration state DB 314, and information on the number of registered lines is stored in the “number of registered lines” column 905. Information on the calculation result is stored in the “registration ratio” column 906.

As a result, a series of processing is finished. In this manner, the comic content is registered in each DB to be appreciated.

In a flow chart in FIG. 14, the user terminal device 111 determines whether or not image information is registered from the user (for example, comic artist) (Step S1401). When the image information is registered (Step S1401: Yes), the image information is transmitted to the server 101 via the network 301 (Step S1402), and the procedure proceeds to Step S1403. On the contrary, when no image information is registered (Step S1401: No), the procedure directly proceeds to Step S1403.

In Step S1403, the user terminal device 111 determines whether or not sound information is registered from the user (for example, voice actor) (Step S1403). When sound information is registered (Step S1403: Yes), the sound information is transmitted to the server 101 via the network 301 (Step S1404), and a series of processing is finished. On the contrary, when no sound information is registered (Step S1403: No), a series of processing is finished.

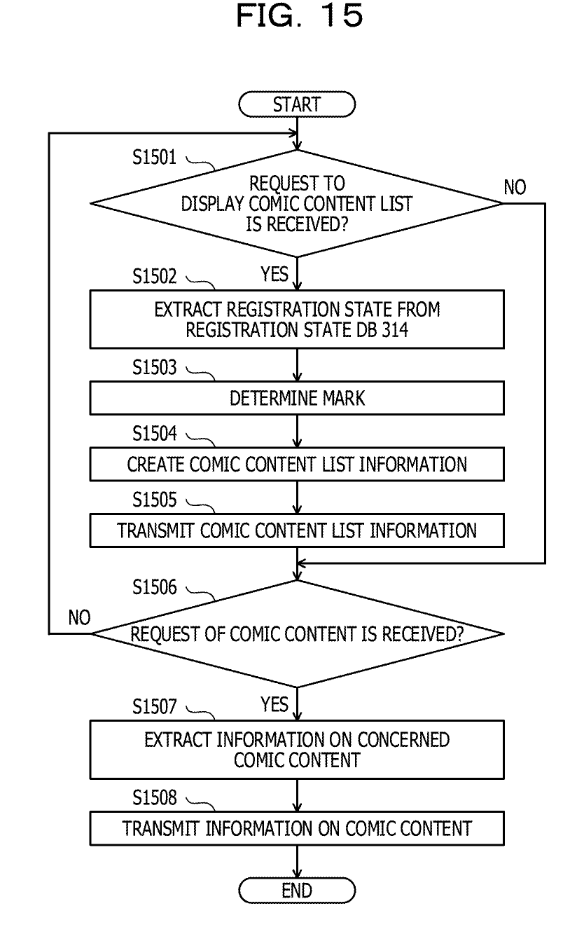

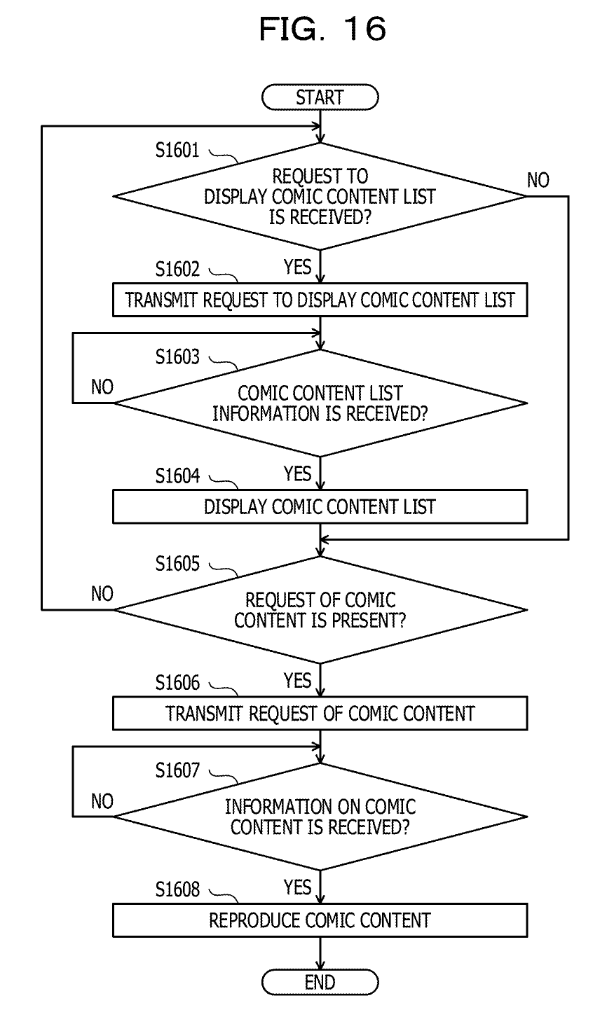

FIG. 15 illustrates an example of comic content offering processing of the server. FIG. 16 illustrates an example of request acceptance processing of the comic content of the user terminal device.

In a flow chart in FIG. 15, the server 101 determines whether or not a request to display the comic content list is received from the user terminal device 111 via the network 301 (Step S1501). When the request to display the comic content list is not received (Step S1501: No), the procedure directly proceeds to Step S1506.

On the contrary, when the request to display the comic content list Step S1501 is received (Step S1501: Yes), information on the registration state (the comic content ID, the character, the total number of lines, the voice actor, the number of registered lines, the registration ratio) is extracted from the registration state DB 314 (Step S1502). A mark associated with each comic content to be displayed is determined using the mark information DB 315 (Step S1503).

Next, comic content list (screen) information including the determined mark is created (Step S1504), and the created comic content list information to the user terminal device 111 that issues the request via the network 301 (Step S1505).

Then, the server 101 determines whether or not a request of (to offer) the comic content is received from the user terminal device 111 via the network 301 (Step S1506). When the request of the comic content is not received (Step S1506: No), the procedure proceeds to Step S1501, and the processing in Steps S1501 to S1506 is repeated.

When the request of the comic content is received in Step S1506 (Step S1506: Yes), information on the concerned comic content is extracted from the comic content DB 311, the image information DB 312, and the sound information DB 313 (Step S1507). The extracted information on the comic content is transmitted to the user terminal device 111 via the network 301 (Step S1508), and a series of processing is finished.

In a flow chart in FIG. 16, the user terminal device 111 determines whether or not a request to display the comic content list is made from the user (audience) (Step S1601). When the request to display the comic content list is not made (Step S1601: No), the procedure directly proceeds to Step S1605.

On the contrary, when it is determined the request to display the comic content list is received in Step S1601 (Step S1601: Yes), the request to display the comic content list is transmitted to the server 101 (Step S1602). Then, it is determined whether or not the comic content list information is received (Step S1603). When the reception of the comic content list information is waited (Step S1603: No), and the comic content list information is received (Step S1603: Yes), the comic content list is displayed based on the received comic content list information (Step S1604), the procedure proceeds to Step S1605.

In Step S1605, it is determined whether or not a request of the comic content is made (Step S1605). When the request of the comic content is not made (Step S1605: No), the procedure returns to Step S1601, and the processing in Step S1601 to S1605 is repeated.

On the contrary, when the request of the comic content is made (Step S1605: Yes), the request of the comic content is transmitted to the server 101 (Step S1606). Next, it is determined whether or not information on the comic content is received (Step S1607). Reception of the information on the comic content is waited (Step S1607: No), and when the information on the comic content is received (Step S1607: Yes), processing of reproducing the comic content is executed (Step S1608), and a series of processing is finished.

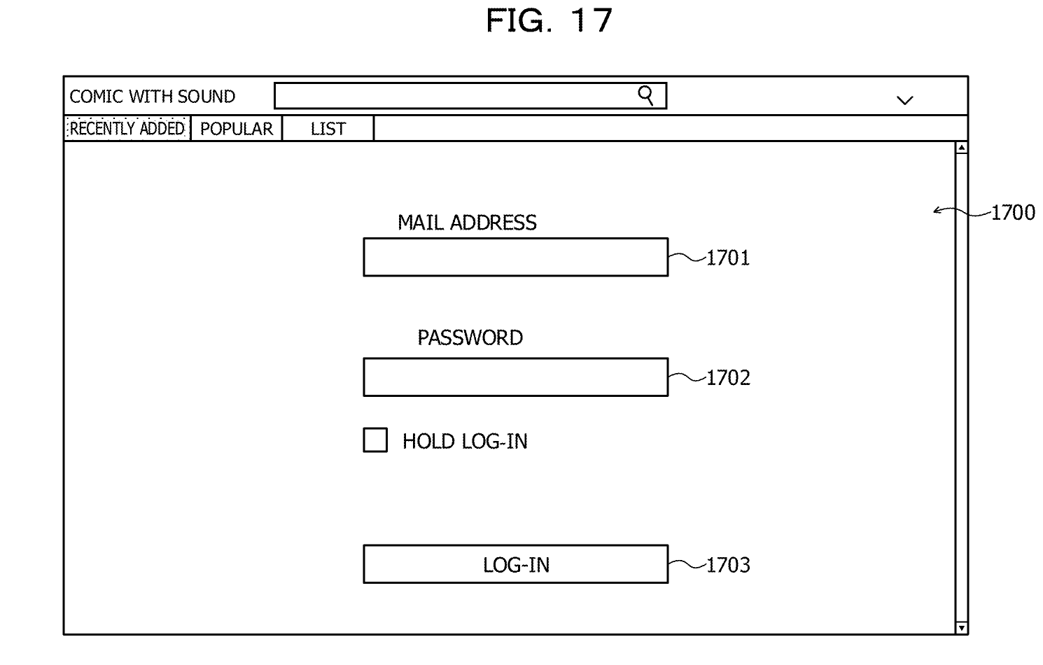

FIG. 17 illustrates an example of a log-in screen displayed on the user terminal device. In FIG. 17, log-in information previously registered for each user is inputted to a log-in screen 1700. The log-in screen 1700 is displayed on the display 503 of the user terminal device 111 in FIG. 5.

In the log-in screen 1700, the user terminal device 111 accepts an input of a mail address from a mail address input column 1701, and an input of a password from a password input column 1702, and when a log-in button 1703 is selected, transmits the accepted log-in information to the server 101. The server 101 may authenticates the log-in using the log-in information received from the user terminal device 111, and at success of long-in, may perform a procedure for the user terminal device 111 to register image information or sound information, or purchase a work.

The server 101 may know an ID of the user (comic artist, voice actor) from the user's log-in operation, and at registration of image information or sound information, register the ID of the concerned user in the comic content DB 311 or the sound information DB 313. Processing of charge to the user (audience) may be executed based on the acquired ID.

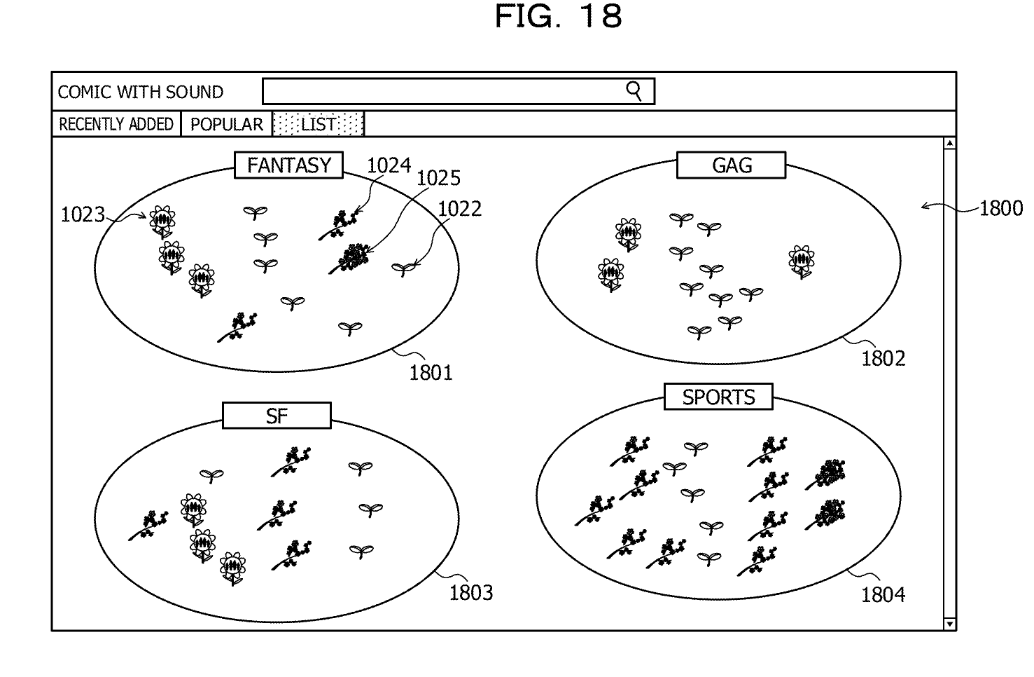

FIG. 18 illustrates an example of a home screen displayed on the user terminal device. In FIG. 18, a home screen 1800 is displayed on the display 503 of the user terminal device 111 in FIG. 5. The home screen 1800 is an example of a home screen of the comic content offering system, and comic contents are disposed in areas 1801 to 1804.

The areas 1801 to 1804 are areas divided by genre of comic contents. The number of marks in each of the areas 1801 to 1804 indicates the number of comic contents (works), and the type of the marks indicates the level of addition of sound information. The mark 221 (see FIG. 2) representing the first phase is not displayed on the home screen 1800 in FIG. 18 and however, the mark 221 may be displayed.

12 marks in total are displayed in the “fantasy” area 1801 on the home screen 1800. This indicates that 12 comic contents with sound information are registered.

12 marks includes six marks representing a second phase, three marks representing a third phase, two marks representing a fourth phase, and one mark representing a fifth phase. This indicates that there are six comic contents in which sound information is added to lines of some characters, not all characters in the genre “fantasy”.

In the genre “fantasy”, there are three comic contents in which one piece of sound information is added to lines of all characters. In the “fantasy” genre, there are two comic contents in which sound information is added to lines of all characters, and sound information is redundantly added to lines of some characters. In the genre “fantasy”, there is one comic content in which sound information is added to lines of all characters, and many pieces of sound information are added to lines of some characters.

For example, in the genre “sports”, the marks representing the fourth phase are displayed the most. That is, there are most common comic contents in which sound information is added to lines of all characters, and sound information is redundantly added to lines of some characters. It is apparent from such displayed contents that in the genre “sports”, there are many comic contents in which sound information is added to lines by a lot of participating voice actors.

When all marks may not be displayed in the areas 1801 to 1804 due to the large number of comic contents, for example, one mark may be displayed for ten comic contents. In this case, although not illustrated, the mark is expressed in the unit of ten comic contents.

The home screen 1800 enables the user to recognize the number of registered comic contents and the level of added sound information for each genre at a glance. For this reason, the user (voice actor) may actively add sound information to lines in comics without sound information. The user may easily find less popular genre and actively register voice in the genre. The user (audience) may easily recognize comics with sound information.

FIGS. 19A and 19B each illustrate an example of a comic content list screen displayed on the user terminal device. A comic content list screen 1900 in FIGS. 19A and 19B is displayed on the display 503 of the user terminal device 111 illustrated in FIG. 5. The comic content list screen 1900 in FIG. 19B is a screen viewed by scrolling the comic content list screen 1900 in FIG. 19A downward by use of a scroll bar or the like. Accordingly, the comic content list screens 1900 in FIGS. 19A and 19B are a series of screens. Comic content information 1901 to 1903 (FIG. 19A), 1904 to 1906 (FIG. 19B) and a menu column 1910 for comic genre and so on are displayed on the comic content list screen 1900.

The comic content information 1901 to 1906 introducing the summary of each comic content includes basic information, charge information, marks 1911 to 1916, and language information. The basic information includes an image of the comic content (a rectangle on upper left side), title, genre, and creator name (comic artist name). The charge information denotes a price for appreciating the comic content. The price denoted by the charge information may include a price for viewing only image information in the comic content, and a price for listening added sound information may be separately charged.

The marks 1911 to 1916 each represent any of the mark 221 to 225 (“1A” to “1E” in the “mark 1” column 1002 of the mark information DB 315 in FIG. 10) in five-phase display mode in FIG. 2 based on the registration ratio of each comic content (“registration ratio” column 906 of the registration state DB 314 in FIG. 9). The mark 1911 to 1916 may include a numeral (%) indicating the registration ratio.

Both of the mark 1914 in the comic content information 1904 and the mark 1915 in the comic content information 1905 have the registration ratio of 100%, and have different level of multiplicity that sound information is redundantly registered. For example, the mark 1915 in the comic content information 1905 has more displayed flowers than the mark 1914 in the comic content information 1904, which indicates more redundant sound information.

On the comic content list screen 1900, the language of added sound information may be displayed as an image of national flag. For example, a Japanese national flag mark 1921 denotes voice information in Japanese, an English national flag mark 1922 denotes voice information in English, and a Chinese national flag mark 1923 denotes voice information in Chinese. When any of the comic content information 1901 to 1906 is selected on the comic content list screen 1900 according to the user's operation, the screen proceeds to a comic content detail screen 2000 illustrated in FIG. 20A.

FIGS. 20A and 20B illustrates an example of a comic content detail screen displayed on the user terminal device. In FIG. 20A, on the comic content detail screen 2000, a rectangular image 2001 representing comic content is displayed on the upper left side. A work detail column is displayed on the upper right side, selection buttons (the “recording” button 2014 and the “appreciation” button 2015) are displayed on the right side of the work detail column, and voice lists 2021 to 2023 are displayed on the lower side. The work detail column illustrates detailed description of the title “F story”.

The work detail column includes a sound information detail 2012. The sound information detail 2012 represents the number of characters appearing in a work to be displayed (“10”), and the number of characters having all lines to which sound information is added (“10”). Further, work description 2013 may be displayed.

The voice lists 2021 to 2023 are displayed such that sound information corresponding to lines of the character may be selected for each voice actor. The voice lists 2021 to 2023 each include a voice actor name, evaluation on the voice actor, the registration level of the voice actor, language information, and selection button.

The voice actor name is a registered name of the user who registers sound information. The evaluation on the voice actor is the evaluation of the voice actor by the user (audience) who purchases sound information. The evaluation on the voice actor is evaluation such as popularity and unpopularity, which is represented as the number of users who makes the evaluation. In the voice list 2021, “popularity” is “31” and “unpopularity” is “5”, which may be determined that the voice actor has a relatively good reputation. The audience may determine whether or not to appreciate the work based on the evaluation. Such numerical expression of the evaluation may be used as a guideline for selecting the voice actor by the audience, increase the voice actor's willingness to participate, and improve the quality of the voice actor.

Although not illustrated, detailed information on the evaluation may be accepted from the evaluating user, such that another user may view the accepted detailed information. In this manner, the audience may check basis and reasons for the evaluation on the voice actor.

The registration level of voice actor is a ratio of the number of lines recorded by each voice actor to the number of all lines of a character (for example, leading role). As illustrated by signs 2031 to 2033 in FIGS. 20A and 20B, the ratio may be expressed in bar graphs. Although not illustrated, pie graphs may be used in place of bar graphs. As in FIGS. 19A and 19B, the language information is language of lines recorded by each voice actor.

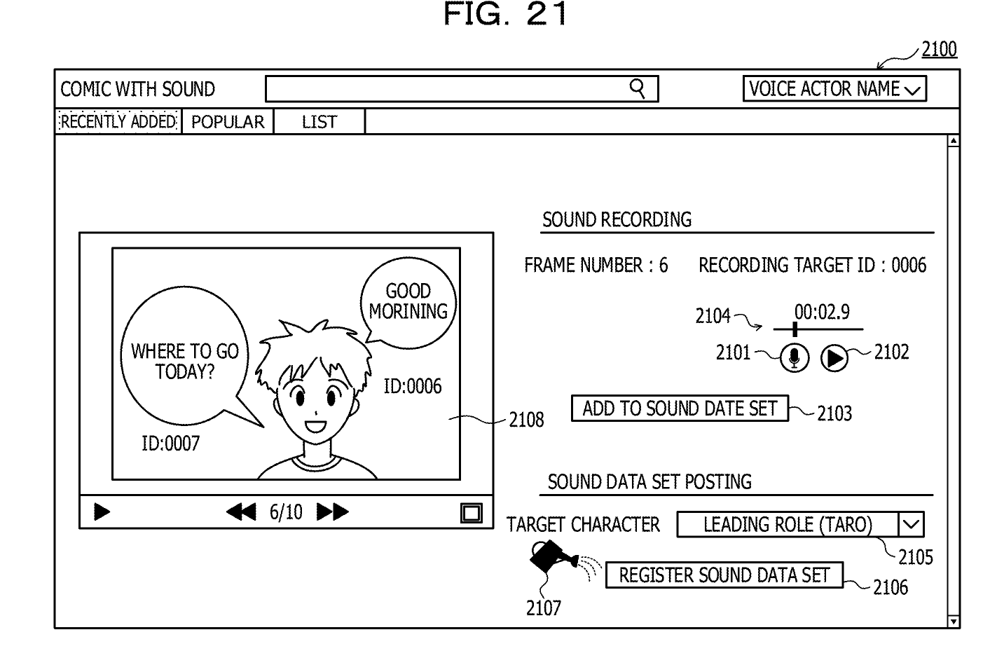

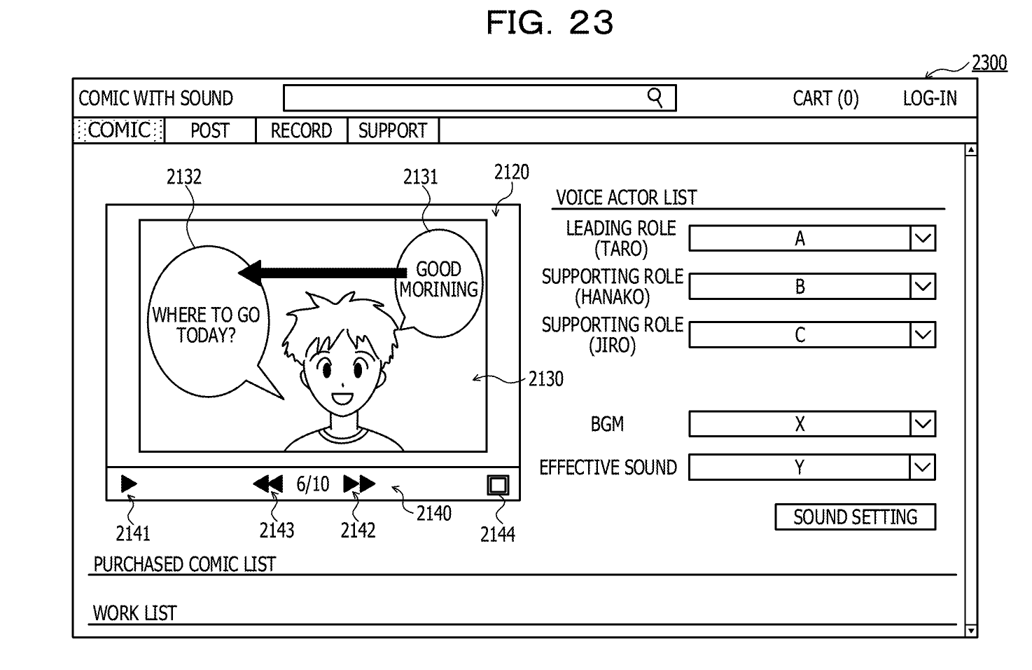

Among selection buttons for selecting desired sound information, the “recording” button 2014 is a button for accepting start of recording from the user (voice actor). When the “recording” button 2014 is selected, the current screen shifts to a recording screen 2100 in FIG. 21 on which sound information may be added to displayed image information. The “appreciation” button 2015 is a button for accepting start of appreciation of the comic content by the user (audience) or purchase of the comic content. When the “appreciation” button 2015 is selected, the current screen shifts to an appreciation screen 2300 in FIG. 23 on which the comic content may be appreciated.

FIG. 21 illustrates an example of a recording screen displayed on the user terminal device. In FIG. 21, the recording screen 2100 displays an operation screen on the right side, and a reproduction screen of image information on the left side. The operation screen displays a recording start button 2101, a reproduction button 2102, a registration button (“add to sound data set”) 2103, a gauge 2104, a target person selection button 2105, and a registration button (“register sound data set”) 2106.

The recording start button 2101 is a button for accepting start of recording. Information to be recorded includes sound information corresponding to lines of each character and sound information such as BGM (Back Ground Music) and effective sound. The reproduction button 2102 is a button for reproducing the recorded sound information.

Recording is made using the microphone 507 of the user terminal device 111 illustrated in FIG. 5. Recording may be made within an effective time set for each balloon. The effective time is expressed by the gauge 2104, and is a time elapsed when specifically, a scale of the gauge 2104 moves from a left end to a right end. In recording, to suggest the reading timing of each voice actor, the user terminal device 111 may sequentially change the display mode of read letters with the progress within the effective time, like lyrics displayed in a karaoke machine.

The registration button 2103 serves to register recorded sound information in a sound data set. The gauge 2104 represents the effective recordable time for each line. The target person selection button 2105 is a button for selecting a character to be recorded. The registration button 2106 is a button for transmitting the recorded sound information to the server 101 and registering the sound information.

A registration promotion icon (watering pot icon) 2107 for promoting registration is displayed near the registration button 2106. This is due to that plants are used as the first type of mark and the second type of mark. Watering to plants with a watering pot to raise the plant conveys a message that sound information is registered to develop the comic content. This promotes registration of sound information. The registration promotion icon is changed to an icon for promoting the growth of the concerned mark or the level of completeness according to the mark displayed on the home screen 1800 or the comic content list screen 1900.

When the registration button 2106 is operated to register sound information, the display mode of the marks on the home screen 1800 illustrated in FIG. 18 or the marks on the comic content list screen 1900 illustrated in FIG. 19A and 19B changes. In this manner, in the server 101, the addition of sound information to lines is reflected on the mark, to visualize the addition of sound information (voice). This may further increase the voice actor's willingness to participate.

A frame image 2108 on the image information reproduction screen denotes one frame in a comic. The frame image 2108 includes a balloon image. When the voice actor taps the balloon image to be recorded, the balloon image is selected as a recording target.

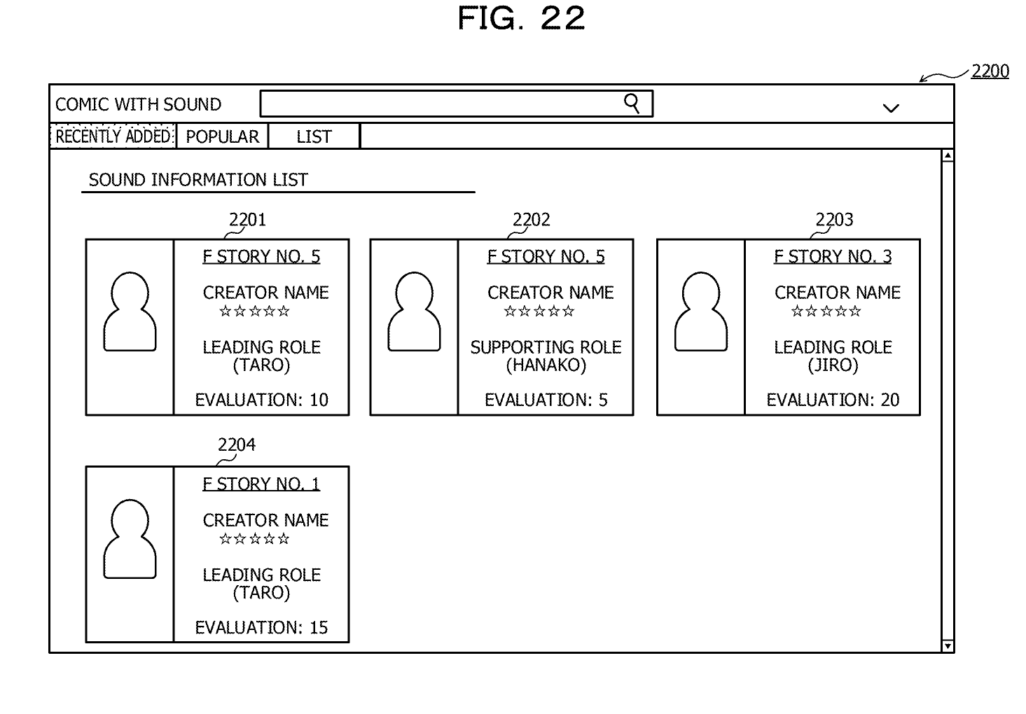

FIG. 22 illustrates an example of a sound information list screen displaying sound information for each voice actor. In FIG. 22, a sound information list screen 2200 displays a list of a plurality of icons 2201 to 2204. Each of the 2201 to 2204 displays sound information registered by the voice actor and the number of evaluations from audiences. For example, the icon 2201 displays sound information on a leading role of “F story, No. 5”. Ten users (audiences) evaluate the sound information.

When the voice actor selects, for example, the icon 2201, details of sound information in the icon 2201 are displayed. Specifically, the sound information in the icon 2201 may be viewed, and another screen (not illustrated) representing the evaluation of audiences is displayed.

FIG. 23 illustrates an example of an appreciation screen displayed on the user terminal device. In FIG. 23, the appreciation screen 2300 is displayed on the display 503 of the user terminal device 111 in FIG. 5. The appreciation screen 2300 includes a voice actor list displayed on the right side and an appreciation image 2120 displayed on the left side. The voice actor list is displayed for the user to select purchased sound information. The purchased sound information may include sound information such as BGM and effective sound in addition to sound information corresponding to lines of characters.

The appreciation image 2120 presents one frame of a comic. The appreciation image 2120 includes a comic image 2130 and a button display 2140. The comic image 2130 includes balloon image 2131, 2132 of the comic. The button display 2140 includes a play button 2141, a skip button 2142, a return button 2143, and an expansion button 2144.

When the user operates the play button 2141, reproduction of voice starts via the speaker 504 (see FIG. 5). Sound information corresponding to the balloon image (“Good morning”) 2131 located on the right or upper side is preferentially reproduced. When reproduction of the sound information corresponding to the balloon image 2131 is finished, sound information corresponding to the balloon image (“Where to go today?”) 2132 is reproduced.

The sound information corresponding to the balloon image 2131 may be reproduced when the user taps the balloon image 2131, and the sound information corresponding to the balloon image 2132 may be reproduced when the user taps the balloon image 2132. For example, even during reproduction of the sound information corresponding to the balloon image 2131 or 2132, when the user taps the balloon image 2131 or 2132, sound information corresponding to a tapped place may be reproduced.

When the user operates the skip button 2142 once, a next frame is reproduced, and when the user operates the skip button 2142 plural times, a later frame corresponding to the number of times of operation is reproduced. When the user operates the return button 2143 once, an immediately preceding frame is reproduced, and when the user operates the return button 2143 plural times, a previous frame corresponding to the number of times of operation is reproduced. When the user operates the expansion button 2144, the comic image 2130 may be displayed on a whole screen of the display 503 of the user terminal device 111 illustrated in FIG. 5.

During reproduction of voice corresponding to the balloon, letters described in the balloon may be hidden. By making letters hidden, the user may concentrate on an image in the frame and voice of the voice actor to find a new way to enjoy comics. Some voice actors may not literally speak letters in the balloon, such that the user may further enjoy the voice actor's view of world that is different from the original. The voice actor may register voice in the balloon with a unique concept without being restricted by letters in the balloon of the original.

FIG. 24 illustrates an example of marks that vary according to the level of addition of sound information. In FIG. 24, marks 2401 to 2405 are pict icons representing the level of addition of the sound information as a growth process of a dinosaur. When sound information is added, the marks 2401 to 2405 grow to a next phase.

The mark 2401 as an example of a first type of mark represents the state of the comic content 200a in a first phase in which sound information is not added, and is a pict icon representing an egg of a dinosaur (for example, “2A” in “mark 2” in the mark information DB 315 in FIG. 10). This corresponds to the pict icon of the mark 221 representing seeding in FIG. 2.

The mark 2402 as an example of the first type of mark represents the state of the comic content 200b in a second phase in which sound information is added to lines of the character 201 among a plurality of characters 201, 202, and is a pict icon representing the state where the egg of the dinosaur has hatched (for example, “2B” in “mark 2” in the mark information DB 315 in FIG. 10). This corresponds to the pict icon of the mark 222 representing germination in FIG. 2.

The mark 2403 as an example of the first type of mark represents the state of the comic content 200c in the third phase in which sound information is added to lines of all characters 201, 202 among a plurality of characters 201, 202, and is a pict icon representing a young dinosaur (for example, “2C” in “mark 2” in the mark information DB 315 in FIG. 10). This corresponds to the pict icon of the mark 223 representing the opened flower in FIG. 2.

The mark 2404 is in a fourth phase in which sound information is added to lines of all of the plurality of characters 201, 202, and sound information is redundantly added to lines of any of the character 201, 202. For example, the mark 2404 is a pict icon representing an adult dinosaur (for example, “2D” in “mark 2” in the mark information DB 315 in FIG. 10). This corresponds to the pict icon of the mark 224 representing the state where flowers have opened on a tree in FIG. 2.

The mark 2405 is in a fifth phase in which the display mode varies according to the multiplicity of redundantly registered sound information, and for example, as the number of pieces of redundantly registered sound information, the number of dinosaurs represented as icons increases (for example, “2E” in “mark 2” in the mark information DB 315 in FIG. 10). This corresponds to the pict icon of the mark 225 representing the state where more flowers have opened in FIG. 2.

The above-mentioned marks 2401 to 2405 enable the user to recognize the level of addition of sound information at a glance. Such marks are not limited to the marks 2401 to 2405 representing the growth process of the animal, and may be marks representing the process of constructing a building. For example, a mark of a basic structure representing a first phase, a mark of a framework representing a second phase, a detached house representing a third phase, a high-rise apartment representing a fourth phase, and a mark of plurality of high-rise apartments representing a fifth phase may be used. By gradually increasing the level of completeness, the user may recognize the level of addition of sound information at a glance. Accordingly, the growth process and the process of increasing the level of completeness may have the same meaning.

For example, marks representing the process of collecting members of a music band are also available. As an example, a mark of drum representing a first phase, a mark of base representing a second phase, a mark of guitar representing a third phase, a mark of vocal representing a fourth phase, and a mark of a plurality of musical instruments representing a fifth phase may be used.

In the case of the musical piece rather than the comic, marks representing musical instruments with sound information may be assigned. Specifically, when sound information of guitar is added, a mark of guitar may be assigned, and when sound information of base is added, a mark of base may be assigned. When sound information of guitar is redundantly registered, plural guitar marks may be assigned according to the multiplicity. Such marks may inform the level of addition of sound information to each musical instrument in each music piece to the user.

As has been described, in the embodiment, the comic content offering system 300 may offer information that allows the user to easily recognize the state of the content. For example, in displaying the list of displayable comics, when the amount of sound information that satisfies the predetermined condition is added to the comic to be displayed, the comic content offering system 300 may assign the first type of mark to the comic. Thus, in displaying the comic list, the comic content offering system 300 may visually inform that the comic to be displayed is viewable with sound information to the user (for example, audience) to promote the audience to appreciate the comic. Accordingly, the comic content offering system 300 may facilitate the audience to search a desired comic, thereby increasing the user's willingness to appreciate the comic to increase the number of audiences.

In displaying the list of displayable comics, when the amount of sound information that satisfies the predetermined condition is not added to the comic to be displayed, the comic content offering system 300 may not assign the first type of mark to the comic. Thus, in displaying the comic list, the comic content offering system 300 may inform that sound information is not added to the comic to the user (for example, voice actor) to promote the voice actor to add sound information. Accordingly, the server 101 allows the voice actor to efficiently add sound information, thereby increasing the voice actor's willingness to participate to increase the number of voice actors.

For example, in the comic content offering system 300, the comic artist may post a comic, and the voice actor adds voice to the posted comic to complete a work. In this manner, many users together may develop the work. Accordingly, the user may make a work as if the user plays a game. Unlike animations and movies (live action version), the comic content offering system 300 may offer works without spending a large sum of money, and also offer works that are not changed in image from originals so much to audiences.

In the comic content offering system 300 according to this embodiment, the user may freely participate, and voice actors or comic artists may compete with each other based on the evaluation from the audience, to offer the opportunity of finding and training new voice actors and comic artists. In the comic content offering system 300, when the comic artist posts a comic, or the voice actor adds voice, a predetermined amount of participation fee may be charged. However, money may be returned to popular comic artists and voice actors according to sales. This enhances the skill of comic artists and voice actors to improve the quality (value) of works.

When an amount of sound information that satisfies the predetermined condition is not added to a comic to be displayed, the comic content offering system 300 may assign the second type of mark indicating that the sound information is not added. Thereby, the comic content offering system 300 may inform comics without sound information in the comic list to the user. Accordingly, the server 101 may promote voice actors to add sound information to bring efficiency to addition of sound information by voice actors. Therefore, the audience may readily search a desired comic.

When an amount of sound information that satisfies the predetermined condition is added to a comic to be displayed, the comic content offering system 300 may assign marks that vary according to the type of language. Thereby, sound information in any of various languages may be added to comics, and the added language may be informed to the user. Accordingly, the comic content offering system 300 is available in one country as well as among many countries. This may further increase the number of users to widespread and develop the comic content offering system 300 worldwide.

When the amount of sound information having a sound information registration ratio that is equal or greater than a predetermined ratio, the comic content offering system 300 may assign the first type of mark. The sound information registration ratio refers to a ratio of the number of lines with corresponding sound information to the total number of lines of the character included in a comic to be displayed. In displaying the comic list, comic content offering system 300 may easily inform the level of completeness of added sound information to the user.

The comic content offering system 300 may add information on the total number of characters in a work to be displayed, and the number of characters having all lines with sound information. Thereby, the comic content offering system 300 may inform the level of completeness of added sound information as a specific number of characters to the user. This promotes the voice actor to add sound information. The audience may select a work in consideration of the number of characters.

The comic content offering system 300 may assign a mark (for example, a level gauge illustrated by sign 2031 in FIG. 20) that varies according to the registration level of sound information to lines corresponding to one of characters in a work to be displayed. This may inform the registration level of sound information to lines corresponding to one character to the user. Accordingly, this may promote voice actors to add sound information. The audience may select a work in consideration of the registration level of sound information to lines corresponding to one character.

The comic content offering system 300 may assign a first type of mark that varies according to a ratio of the number of lines with sound information to the total number of lines of a character included in a work to be displayed. Accordingly, the comic content offering system 300 may change the display mode of the first type of mark according to addition of sound information by the voice actor. The voice actor may add voice to lines, thereby growing the first type of mark to visualize the growth level, and obtain a feeling of achievement and delight as if he/she plays a game. Therefore, the comic content offering system 300 may improve the willingness of the voice actor to participate.

The comic content offering system 300 may assign a first type of mark (mark 224 representing that flowers on a tree have opened in FIG. 2) representing that sound information is redundantly added to lines of one of characters in a work to be displayed. Thereby, the comic content offering system 300 may suggest a comic in which many voice actors participate in the comic list to the audience, increasing the audience's willingness to appreciate the comic.

The comic content offering system 300 may assign the first type of mark (the mark 225 representing that the number of flowers increases in FIG. 2) that varies according to the multiplicity of sound information added to lines of one character. Accordingly, the server 101 may change the display mode of the first type of mark according to the multiplicity of sound information, to inform works in which many voice actors participate (popular works) to the user.

In the comic content offering system 300, the voice actor may add voice to lines as if he/she plays a game to increase the voice actor's willingness to participate. For the comic in which a large number of voice actors are participate in the comic list, the server 101 may present the number of participants to audience using the first type of mark to increase the audience's willingness to appreciate.

In this embodiment, results of the evaluation of the voice actors from the audience may be displayed (see FIG. 22). Examples of contents of the evaluation of the voice actor include whether or not voice of the voice actor is suitable for the character, whether or not emotion expression is rich, and whether or not translation is good. As a result, voice actors may compete with each other, thereby improving the quality of sound information to diversify the sound information.

As described above, in this embodiment, anyone as the voice actor may readily register his/her voice to promote the participation of voice actors. This efficiently offers the opportunity to freely participate in an audition to voice actor or would-be voice actors on the Internet, thereby discovering new voice actors and educating voice actors. Therefore, the voice actor market and the voice actor field may be expanded.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium for recording a content display program, the content display program causing a computer to execute processing, the processing comprising:
displaying, in displaying a list of content, when sound information having an amount that satisfies a specific condition is added to the content, a first type of mark indicating that the content is viewable with the sound information in association with the content; and
not-displaying, when the sound information is not added to the content, the first type of mark in association with the content.

2. The non-transitory computer-readable recording medium according to claim 1, further comprising:
displaying, when the sound information is not added to the content, a second type of mark, which is other than the first type of mark and indicates that the sound information is not added, in association with the content.

3. The non-transitory computer-readable recording medium according to claim 1, wherein
the sound information includes voice information in a language, and
a mark that varies according to a type of the language is displayed in association with the content.

4. The non-transitory computer-readable recording medium according to claim 2, wherein
the sound information includes voice information on lines of a character in the content, and
the specific condition is whether or not a ratio of an amount of the lines with the voice information to a total amount of the lines in the content exceeds a specific ratio.

5. The non-transitory computer-readable recording medium according to claim 4, wherein
the second type of mark includes a plurality of different types of marks corresponding to the amount of the lines with the voice information in the total amount of the lines in the content.

6. The non-transitory computer-readable recording medium according to claim 5, wherein
the second type of mark including the plurality of different types of marks is a mark indicating process of growing as the amount of the lines with the voice information in the total amount of the lines increases.

7. The non-transitory computer-readable recording medium according to claim 5, wherein
the second type of mark including the plurality of different types of marks is a mark indicating that a level of completeness becomes higher as the amount of the lines with the voice information in the total amount of the lines increases.

8. The non-transitory computer-readable recording medium according to claim 1, wherein
the first type of mark includes a plurality of different types of marks corresponding to multiplicity of the added voice information in the content.

9. The non-transitory computer-readable recording medium according to claim 1, wherein
the sound information includes voice information on lines of a character in the content, and
third information on a total number of the characters in the comic content, and fourth information on a number of the characters having all lines to which the voice information is added are displayed in association with the content.

10. The non-transitory computer-readable recording medium according to claim 1, wherein
the sound information includes voice information on lines of a character in the content, and
a mark that varies according to a ratio of a amount of the lines with the voice information to a total amount of the lines of the character are displayed in association with the content for each character in the content.

11. The non-transitory computer-readable recording medium according to claim 10, wherein
the mark that varies according to the ratio of the amount of the lines with the voice information to the total amount of the lines of the character in the content is a graph representing the ratio.

12. The non-transitory computer-readable recording medium according to claim 1, wherein
the content relates to a comic work.

13. A content display method, comprising:
displaying, by a computer, in displaying a list of content, when sound information having an amount that satisfies a specific condition is added to the content, a first type of mark indicating that the content is viewable with the sound information in association with the content; and
not-displaying, when the sound information is not added to the content, the first type of mark in association with the content.

14. The content display method according to claim 13, further comprising:
displaying, when the sound information is not added to the content, a second type of mark, which is other than the first type of mark and indicates that the sound information is not added, in association with the content.

15. The content display method according to claim 13, wherein
the sound information includes voice information in a language, and
a mark that varies according to a type of the language is displayed in association with the content.

16. The content display method according to claim 14, wherein
the sound information includes voice information on lines of a character in the content, and
the specific condition is whether or not a ratio of an amount of the lines with the voice information to a total amount of the lines in the content exceeds a specific ratio.

17. An information processing apparatus comprising:
a memory; and
a processor coupled to the memory and configured to:
display, in displaying a list of content, when sound information having an amount that satisfies a specific condition is added to the content, a first type of mark indicating that the content is viewable with the sound information in association with the content; and
not-display, when the sound information is not added to the content, the first type of mark in association with the content.

18. The information processing apparatus according to claim 17, wherein the processor is configured to;
display, when the sound information is not added to the content, a second type of mark, which is other than the first type of mark and indicates that the sound information is not added, in association with the content.

19. The information processing apparatus according to claim 17, wherein
the sound information includes voice information in a language, and
a mark that varies according to a type of the language is displayed in association with the content.

20. The information processing apparatus according to claim 18, wherein
the sound information includes voice information on lines of a character in the content, and
the specific condition is whether or not a ratio of an amount of the lines with the voice information to a total amount of the lines in the content exceeds a specific ratio.
